(19) United States
(12) Patent Application Publication
(10) Pub. No.: US 2006/0095333 A1
(43) Pub. Date: May 4, 2006

(54) System and method for an electronic commerce product for managing the pricing, inventory, sales, and selection of goods and services offered for sale

(76) Inventor: Robin K. Gambhir, Toronto (CA)

Correspondence Address: WHITE-WELKER & WELKER, LLC, P.O. BOX 199, CLEAR SPRING, MD, 21722-0199, US

(21) Appl. No.: 10/975,231

(22) Filed: Oct. 28, 2004

(51) Int. Cl. G07G 1/12

(52) U.S. Cl. 705/25; 705/28

(57) ABSTRACT

The present invention represents an inventory management and process control system that enables suppliers, distributors, retailers and wholesalers to share their physical inventories with each other. It also provides facilities for publishing that data to retailers' web sites while providing innovative pricing and incentive schemes.

### CROSS REFERENCE TO RELATED APPLICATIONS

This application cross-references U.S. patent application Ser. No. 00/000,000, entitled “System and Method for Inventory Sharing Across a Multi-User Network”, filed on Oct. 00, 2004.

### FEDERALLY SPONSORED RESEARCH

Not Applicable

### SEQUENCE LISTING OR PROGRAM

Not Applicable

### TECHNICAL FIELD OF THE INVENTION

The present invention relates generally to computer networking and software, electronic commerce systems, and product pricing systems. More specifically the present invention relates to an electronic commerce product pricing, inventory, sales, and selection system.

### BACKGROUND OF THE INVENTION

Computer networks such as the Internet and the World Wide Web (WWW) have developed into a convenient medium by which businesses and consumers can sell and purchase goods and services. To facilitate such commercial activity or “electronic commerce”, businesses provide virtual stores electronically utilizing web, application, and transaction servers which a customer can then access using a web browser application. Electronic orders are received using websites displaying a store's inventory. Once received, orders are processed and the store's inventory database is updated.

Today, businesses offer an extremely wide variety of products for sale online. Websites often feature products from the owner's own inventory and products belonging to the inventory of an independent vendor or third party supplier, generating revenue in the form of advertising fees, retail “markups”, or commissions.

Many businesses have attempted to offer the products of others via this “virtual” inventory mechanism in order to present a greater variety of products or a wider selection of a particular product to consumers or to avoid having to invest their own capital in inventory, particularly if a product's acquisition cost is high and/or if the average amount of time between product acquisition and product sale is long, which is a common occurrence in the jewelry industry.

Until recently, inventory electronic commerce systems have been extremely difficult to implement, requiring e-commerce businesses to integrate and maintain vendor and product selection, access to vendor inventory information, and product quality and pricing supervision in a single electronic commerce website. While recently developed e-commerce systems have overcome many obstacles associated with providing access to vendor inventory information, they have yet to address product pricing supervision or the selection of vendors or products based on product price or margin which has made the adaptation of some products to the virtual inventory model even more difficult. Jewelry and jewelry related items and components (such as findings, precious stones and diamonds), are examples of products that have been particularly difficult to adapt to virtual inventory e-commerce systems due to this shortcoming.

Jewelry is typically an attractive product to sell online. Generally, consumers desire large inventories, competitive prices, and the assurance of product when purchasing jewelry online. Inventory systems currently known in the prior art typically allow online jewelry retailers to offer a wider selection of items without having to undertake the typically high acquisition costs and inventory associated with jewelry. Such inventory systems would likewise allow consumers to make a greater variety of purchases at fewer electronic stores in which they have confidence. Conventional pricing methods have prevented jewelry from being combined into a shared, integrated inventory system.

The present invention allows retailers, wholesalers, manufacturers and distributors to create, manage and share their inventories while also sharing those inventory items with other people on the network. Users of the invention can sell, consign and quote on their own inventories as well as those of others on the network. All participants can publish their inventories through their own and, optionally, other members' web sites while employing features such as tiered markups, percentage and dollar discounts, rebates and other incentives. The system can be used by members of the network for their own wholesale or retail sales through the point of sale features afforded by the system. The invention can also work using only the retailer, wholesaler and manufacturers own inventory alone. Since the system offers novel features for inventory management, publication of inventory to a web site, order tracking and process control in addition to some of the point of sale features well known in prior art, it offers a compelling feature set.

One system known in the prior art is Gemfind.net. This system is typical of the online sales model found in the jewelry industry and suffers from many shortcomings. The Gemfind.net system does not utilize multiple currencies, nor offer colored gemstones, pearls, and cameos for sale. While it offers a small assortment of ring mounts, it does not maintain an inventory of semi mounts, bracelets, rings, pendants and earrings that can combine colored gemstones, pearls or cameos within a single piece of jewelry. Nor does it allow for users to add their own mounts or finished jewelry that can be customized in this manner using the system. It does not offer any point of sale features.

What is needed is an online referral based sales system that improves vastly improves upon the existing system's shortcomings and is available to both the jewelry industry and others. An improved sales system should include the ability to accept multiple currencies for payment and enable a larger range of inventory groups and items for sale if desired to consumers. Retailers should have the ability to set price ranges, incorporate tiered markups with respect to the sale item, varying percentage discounts, and dollar discounts.

From the perspective of a wholesaler or retailer the systems known in the prior art provide limited resources and options that can be overcome to provide an improved system. For example, many systems do not offer a wholesaler or retailer to offer varying price ranges for individual items, tiered markups, percentage discounts, and dollar discounts.

What is needed is a system that provides the wholesaler or retailer with more control of their inventory and pricing. The present invention overcomes the previously mentioned shortcomings by providing features that enable a user to build, maintain and monitor their site and inventory. No other system offers the flexibility of operating it entirely through a web browser or through the, more traditional, software-based solution.

### SUMMARY OF THE INVENTION

In accordance with the present invention a method for providing a web service that allows retailers, wholesalers, manufacturers and jewelers to share their inventories in order to increase their sales online and in their “bricks & mortar” locations is provided which overcomes the aforementioned problems of the prior art.

The database of the present invention can contain product from multiple suppliers, wholesalers and distributors. It can also accept entries from retailers who may or may not choose to make those items available to other people on the system. The database of the present invention may store the following information: inventories of loose precious and semi precious gems; diamonds; all varieties of loose pearls and pearl strands; watches and watch parts; jewelry making components, known as “findings” in the industry; any and all finished jewelry including, but not limited to, rings; earrings; pendants; bracelets; chains and bracelets; and semi finished jewelry known as “semi-mounts” in the industry; china; crystal, giftware and another items sold in a jewelry store.

Although the present invention can operate as a traditional inventory management and point of sale system, its feature set is founded upon several assumptions. First, that with next day shipping, the need for retailers to inventory items has been greatly reduced. Second, shared inventories amongst retailers and suppliers allows the retailer to offer a greater selection of goods to their clients that, in the absence of carrying costs, increases the retailers price flexibility. Finally, that for a jeweler to increase their custom made business, they must offer a wide selection of mounts and gems that, in the absence of such an inventory-sharing model, would be too costly.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates the general schema for the present invention;

FIG. 2 is a screen show of the inventory record view of one embodiment of the present invention;

FIG. 3 is a screen shot of a web page illustrating the visual component of the system of the present invention;

FIG. 4 is a screen shot of a web page illustrating the record view of the system of the present invention;

FIG. 5 illustrates the graphical user interface of the present invention that enables items and relevant information to be entered into the databases;

FIG. 6 is a screen shot of a typical log record generated by the system of the present invention;

FIG. 7a is a screen shot of the pricing menu of the present invention;

FIG. 7b is a screen shot of the standard markup menu of the present invention;

FIG. 8a is a screen shot of the tiered markup menu of the present invention;

FIG. 8b is a screen shot of a list of tiered markup settings;

FIG. 9 is a flow chart describing the steps for customizing the drop down menus of the present invention;

FIG. 10 is a screen shot of the wish list feature;

FIG. 11 is flow chart describing the steps for the process of conducting a search;

FIG. 12 is a chart listing the different attributes supported and stored in the database of the present invention;

FIG. 13 is a screen shot illustrating the inventory checkout feature of the present invention;

FIG. 14 is a screen shot illustrating the average weight search and sorting function of the present invention;

FIG. 15 is a screen shot illustrating the customer history function of the present invention;

FIG. 16 is a screen shot illustrating the browse screen of the approvals module of the present invention;

FIG. 17 is a screen shot illustrating the approval entry form of the approvals module of the present invention;

FIG. 18 is a screen shot illustrating an in house approval copy containing bar-coded item numbers and stock codes from one embodiment of the present invention;

FIG. 19 is a screen shot illustrating an entry form from one embodiment of the present invention;

FIG. 20 is a screen shot illustrating an announcement from one embodiment of the present invention;

FIG. 21 is a screen shot illustrating inventory level control from one embodiment of the present invention;

FIG. 22 is a screen shot illustrating the replace all feature from one embodiment of the present invention;

FIG. 23 illustrates the browse duplicate inventory items function of the present invention.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

Referring to the figures, it is possible to see the various major elements constituting the method and system of the present invention. The invention is a combination of a web service, combined with local software, that allows retailers, wholesalers and manufacturers to share their inventories in order to increase their sales online and in their “bricks & mortar” locations.

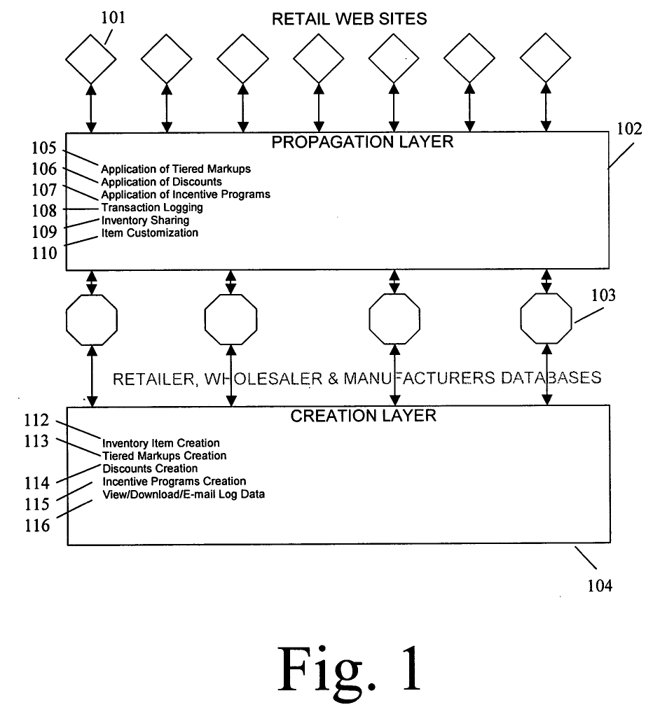

Now referring to FIG. 1 the general scheme of the present invention is shown. Retail websites (101) are connected through a propagation layer (102) to retailer, wholesaler, and manufacturer databases (103) that is controlled via a creation layer (104). The propagation layer (102) contains several applications for the control of specific tasks such as tiered markups (105), discounts (106), incentive programs (107), transaction logging (108), inventory sharing (109), item customization (110), and job/order status (111). The creation layer is comprised of several applications which enable the creation of a retail website accessible via a wide area network such as the World Wide Web. FIG. 1 illustrates some of the typical sub applications that would be common to the system of the present invention such as inventory item creation (112), tiered markup creation (113), discount creation (114), incentive programs creation (115), view/download/email data log (116), retail management/point of sale system, wholesale/distributor inventory management, manufacturing process control and inventory, and management consignment and sale system.

Inventory Module

The browse inventory component of the inventory module displays all items in the database and allows for a plurality of functions such as: a query builder that allows the user to select any of the available database fields and construct simple or complicated queries using AND/OR logic along with field operators (contains, is equal to, does not contain, is not equal to, is greater than, is less than etc; print inventory reports; inventory labels; display inventory items that meet user definable criteria in different colors on the screen; synchronize queried or filtered data with other databases; sort inventory data by single or multiple fields; and group inventory data by single or multiple fields.

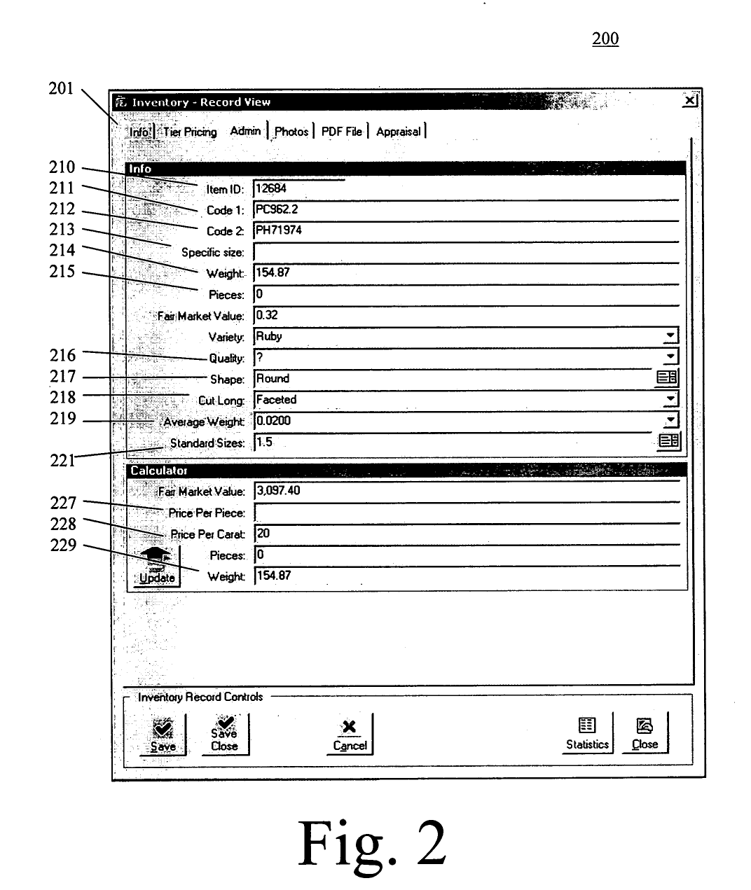

Now referring to FIG. 2 a screen shot of one embodiment of the present utilizing the inventory record view (200) is illustrated. Inventory items (201) are created by filling-in a plurality of fields. Field descriptions and contents can be customized by the user to fit their processes and type of inventory. Field descriptions utilized by the one embodiment of the present invention, but which are not conclusive of all those possible, are: item identification numbers (210) which are assigned by the database, Code1 (211) and Code2 (212) fields for adding items to the database are available in which a user can place their own stock numbers, codes and/or manufacturer SKU. Other fields include: specific size (213) for the times when the size does not exist in the list of standard sizes; current weight (214) of the inventory item; current number of pieces (215) for this inventory item; the type of inventory item (e.g.) gemstone, diamond, pearls, ring, broach, metal findings; a list of user definable quality descriptions (216); a list of user definable shape descriptions (217) wherein a single or multiplicity of shapes can be selected for any one item; a list of user definable cut descriptions (218); if the item is sold by weight, a field which contains the average weight (219) for the item is offered so that an estimated price per piece can be calculated; country of origin (220), a list of user definable standard sizes (221); depending upon the type of item this field could be used for a gemstone size, a ring size or the size of beads in a strand where items have multiple sizes within the item, multiple sizes can be selected. A list of single or multiple colors that describes the color or colors of an item used so that others can search for items on the basis of the constituent colors. A user definable list of appearances that can vary according to the type of inventory item. For example a watch can have a different set of appearance descriptions than a ring, pearl or gemstone. The date and time the inventory record was modified which are automatically updated by the system. An optional field for companies that either do a manual inventory or record inventory at their fiscal year end. The date the inventory record was created which is also filled in automatically by the system. A price range from low to high (227) or, if the item is sold by weight, a list price per carat range (228) from low to high for the item which can be customized to grams for precious metals sold by the gram. The original weight (229) and number of pieces for the item when it was new to the inventory

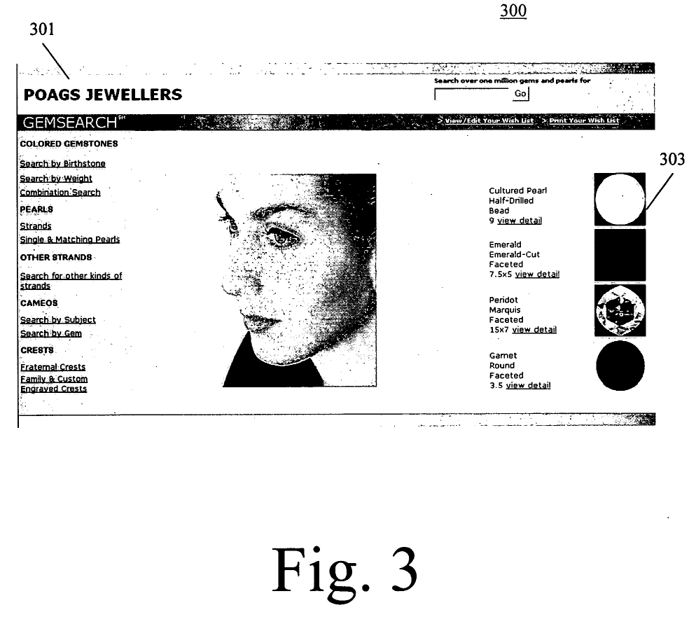

The present invention offers several improvements over the prior art the following features to retailers using the system. Referring to FIG. 3, a sample of the visual display of the present invention is shown. Part of the present invention is to create a series of rotating images so that each time the website (300) is loaded, a new image will appear. Users can upload their photos of their business (301), featured merchandise (303), etc. and these images will automatically appear when their web page (300) is loaded or when the section of their own web site connected to the present invention is loaded. In addition, the home page of each user's site integrated with the present invention displays both randomly selected items from the inventory and ones that the retailer would like to feature.

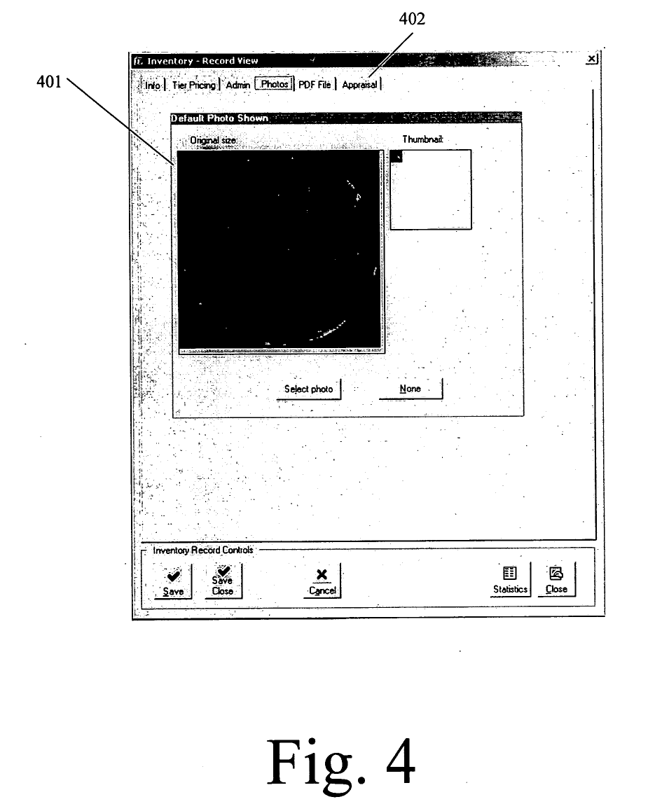

Now referring to FIG. 4 a user can attach a specific single (401) or multiple photos to an inventory item. If photos of the actual item are not available a representative photo, called a default photo, can be used for a given combination of variety, shape and cut fields. So, in the example presented from on embodiment of the present invention, there is a default photo displayed for the following combination Variety=Ruby, Shape=Round and Cut=Faceted.

Inventory items can have multiple Adobe Acrobat PDF files attached to them. These could be original invoices, brochures, information sheets etc. Anything that might relate to that inventory item. In addition, there is a special Tab for Appraisals (402) so that if there is an appraisal or certification available for that item it can be attached here. Any of these documents can be made available to the retail web sites through the propagation layer.

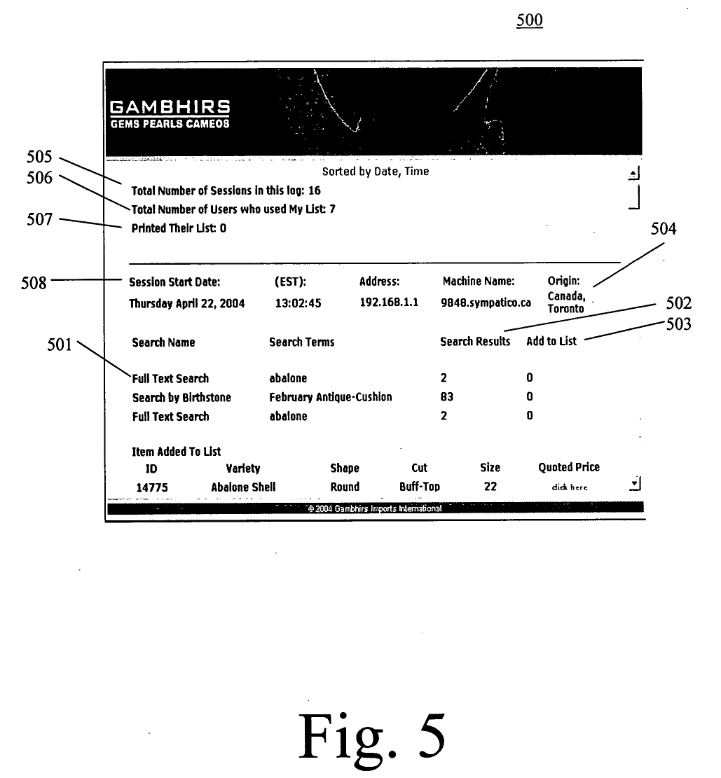

Now Referring to FIG. 5, a sample screen shot of the log record (500) generated by the present invention of all the activity that has taken place on a user's web site is shown. Log data includes the following information about retail clients using the service on a particular retailer's site: the searches users' conduct (501), the number of results (502) and whether they added it to their wish list (503) which could indicate an interest to purchase; the location (504) from where in the world the person doing the searches is located; a list of pages viewed by the user, the order in which they were viewed and how many times the pages were views (if more than once) Logs can be viewed any time and are “live” in that a client can watch what consumers are doing by viewing their log record (500) at the same time consumers are access their website and can be sorted by any of the fields on the log. Log records (500) can also be downloaded for analysis or off-line storage and can be e-mailed at user selectable intervals ranging from every hour to once every month.

Log records (500) normally provide metrics such as the number of entries (505), the number of people who use the wish list (506) and the number who printed their list (507). In addition there are a series of reports and log analysis tools that provide statistics for the type of searches conducted, based upon geographical origin (504), time of day (508) and the search results sent.

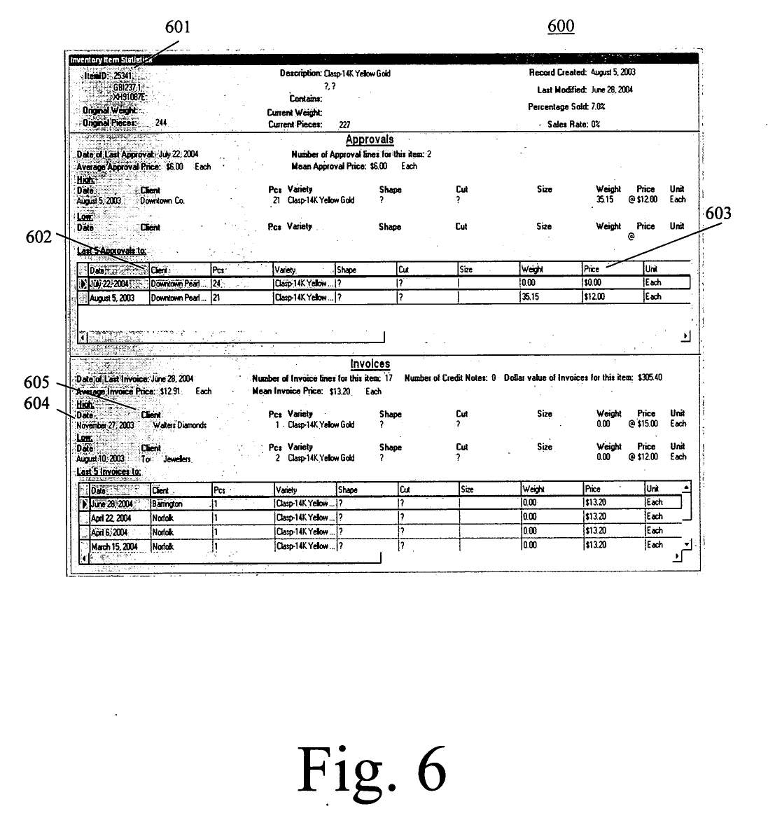

Now referring to FIG. 6, the system of the present invention provides a printed and on-screen report (600) that details the history of any inventory item (601) in the system. The report (600) shows when and to whom the item or part of the item was consigned or sold (602) to a client and the prices paid (603). The report also shows the high and low prices charged for the item (604) and to whom those prices were charged (605). It shows the current quantity in stock (605), the original quantity, the percentage sold, and a percentage that shows how many time the item was consigned and sold. It also shows the average and mean prices for the item.

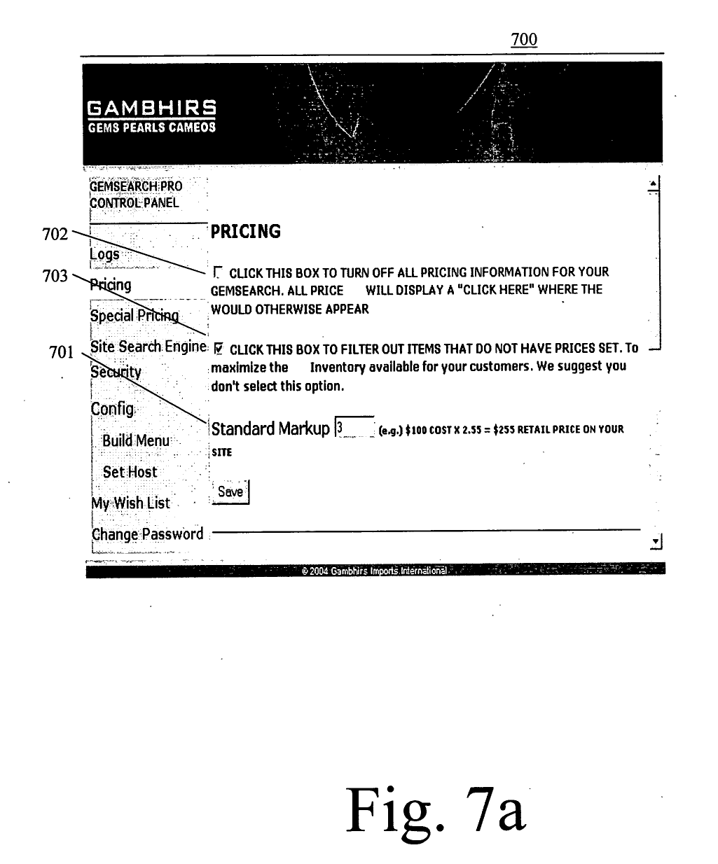

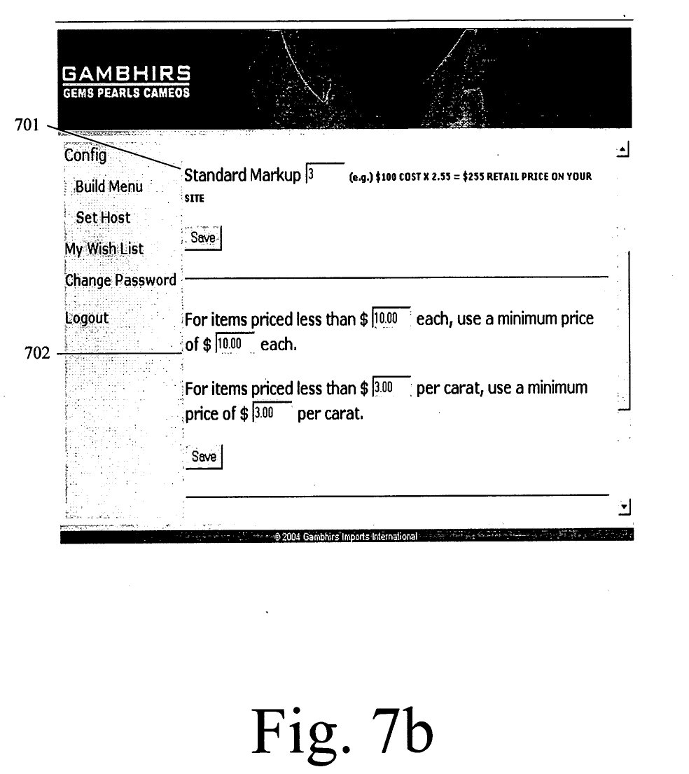

Now referring to FIG. 7a, the pricing menu (700) of the present invention allows a client to set a standard price markup (701), turn off all pricing (702), and filter items that lack pricing from the search results (703). The system of the present invention may also utilize a floor pricing system illustrated in FIG. 7b. Using the floor pricing setting a client can set minimum prices on any items that costs less than so much per carat or gram (701) or per piece (702). For such items the price quoted is based on the rule set for each individual client and would be quoted at the appropriate price.

The system of the present invention may also incorporate a tiered pricing system, which is different from the tiered markups that change the markups depending upon the cost. Here, the owner of the inventory item can set different tiers for the wholesale price based upon volume. Thus, if a person buys more they receive a lower wholesale price that can then be marked up by either the tiered markup or the default markup as the case may be. This tiered cost pricing is completely customizable and can work either by weight or by the piece.

In addition, suppliers, wholesalers and manufacturers can apply their own set of discounts to the wholesale price charged to the retailer. These discounts can be applied on an individual or group basis.

Where the supplier, wholesaler or manufacturer has their own suggested retail price, such items can be flagged to override the markup system and, optionally, the discount system, inherent in the propagation layer. This feature would be useful for branded items where the retailer is not permitted to discount at all or without consent from the manufacturer.

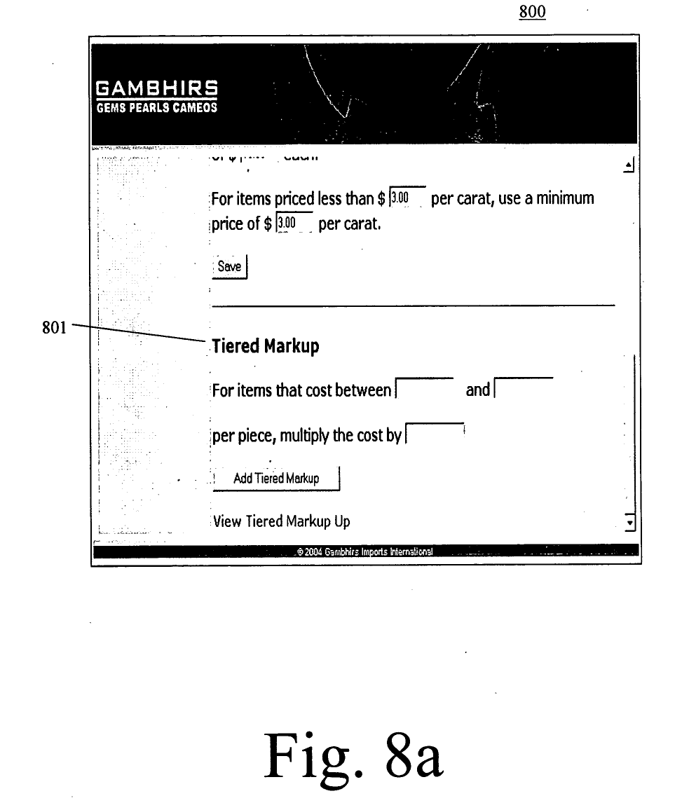

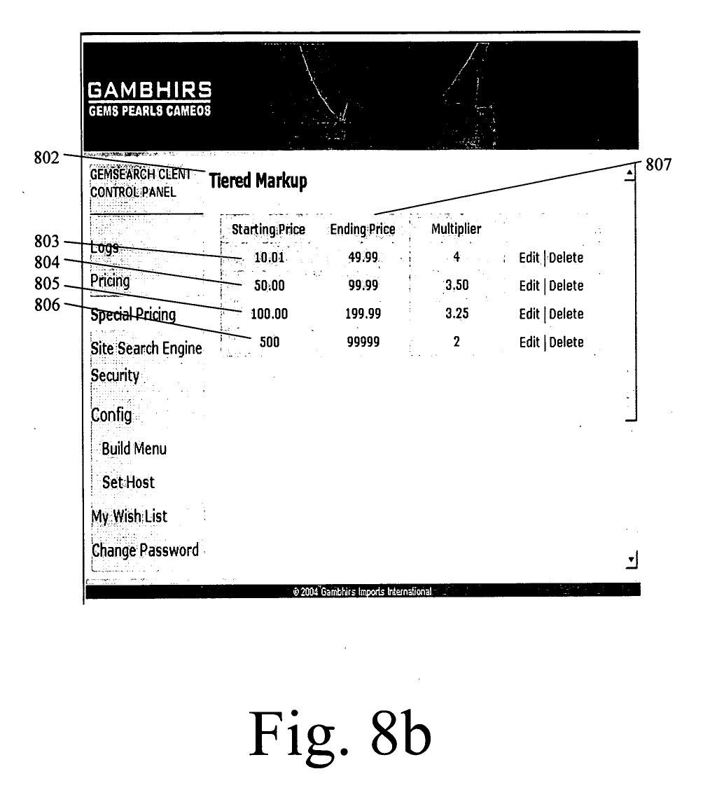

Now referring to FIG. 8a, a screen shot showing a sample website (800) wherein a client may set tiered markups (801) is illustrated. Since the database of the present invention contains items costing from pennies to thousands of dollars, a single markup is not sufficient to maintain profit levels and set competitive market prices. For example, less expensive items often have a larger markup than more expensive items and retailers often charge more for the less expensive items and less for more expensive items. Now referring to FIG. 8b, the tiered markups (802) let retailers set a series of different markups (803, 804, 805, 806) depending upon the cost of the item (807). Clients can set as many or as few tiered markup levels (803, 804, 805, 806) depending as desired and can change them at any time. This feature is optional, and if no tiered markup levels are set or if the item falls outside of the tiered markup levels that have been set, the system will use the standard markup chosen.

In addition to providing the tiered markups, the system of the present invention can support multiple classes of tiered markups. This is applicable to jewelers that do insurance replacements and commonly work on lower markups than they will when selling an item to a retail client. Separate classes of tiered markups allow these jewelers to charge a default markup and the tiered markup depending upon the type of client they are serving or the type of merchandise they are selling.

Special pricing allows clients to have sales and promotions. If a client enters keywords for the sale merchandise, the percent of discount, and the date the sale is over all user search results that match the criteria will then be discounted. The matching items will appear in red in the search results and when the user clicks on view detail, they will see the regular price, the sale price and the date the sale ends. Once the date has passed, all search results return to normal.

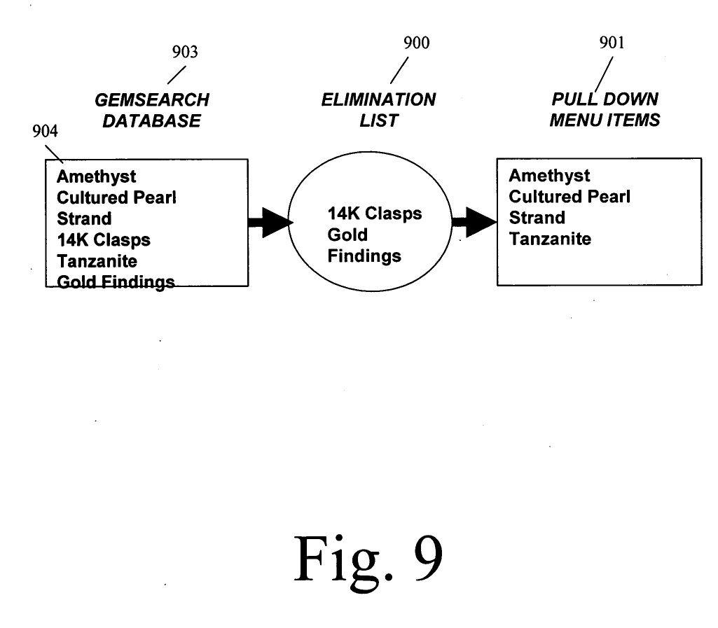

There are two kinds of discounts: percentage discounts wherein there is a set percentage off discount for all items that match the criteria. The second discount option is a dollar off discount that is comprised of a set dollar amount that all items matching the criteria will be discounted. Now referring to FIG. 9, customizable drop-down menus (901) are controlled by the elimination list (900) feature. The elimination list (900) allows a client to control the contents of every pull down menu (901), for every search. The elimination list (900) works in conjunction with the system to customize the pull down menus (901), using the contents of the database (903) and the elimination list (900). For example, the database (903) contains items like gold clasps (904), but a client may not want these items listed for sale on their web site. So the word “clasp” is added to the elimination list (900), and the menus are rebuilt and the eliminated item will no longer appear in the pull down menus (901).

Another novel feature that the system may incorporate is dynamic pricing. Dynamic pricing occurs when an item from any of the associated suppliers or distributor databases is sold or quoted, the system can, depending upon the retailer's settings, update the price range for that time. Price ranges can either be from the lowest price to the highest price or from the median price to highest price. For items that contain wholly or in part, precious metals, prices can be adjusted based upon the daily price for that precious metal.

Every time a client site sends a search to the database, the system database checks to make sure that the query is coming from a legitimate source. Using this item in the control panel, the client must enter the complete URL of the system client files where they exist on the client site (i.e. http://www.mysite.com/gemsearch). If the address entered in the set host field does not match the address where the query originates, the query will be denied and an error message will be generated.

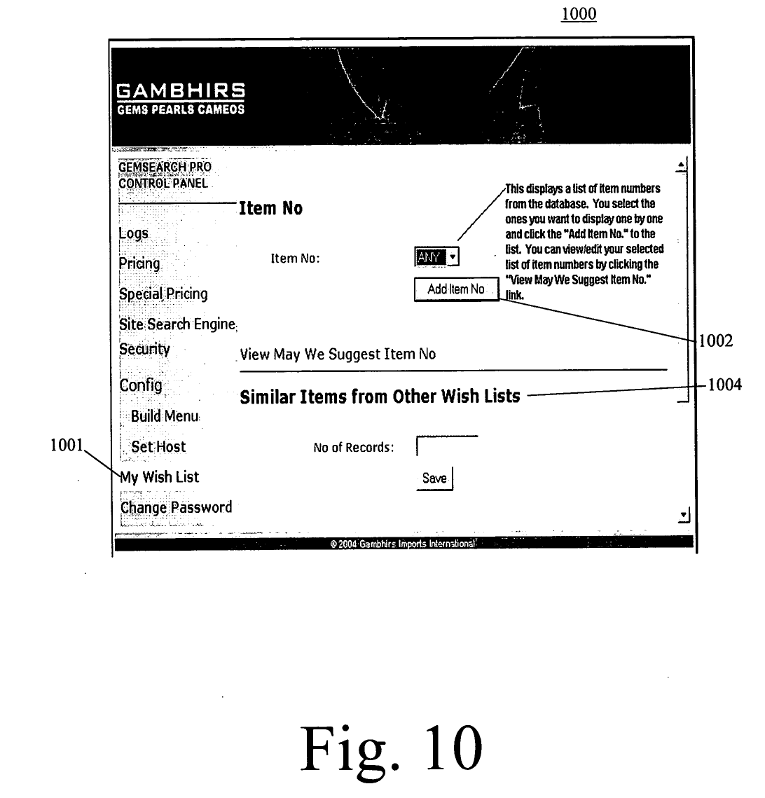

Now referring to FIG. 10, the present invention incorporates a wish list (1001) feature wherein users browsing the jeweler's web site (1000) can keep a running list of items of interest. Users can edit/remove items (1002), print the list or choose to purchase some or all of the items on the list. When the user chooses to view or edit their wish list, they may also see, depending upon whether the jeweler has chosen to implement this feature, either a list of similar items (1004) that other users have added to their wish lists or list of items selected by the jeweler for the users to see. The jeweler can select the number of items from other wish lists to display and can select as many items as desired from the database to display. Items added to the user's wish list are recorded in the log along with the item details and the price or price range quoted.

Searches for items not currently available can also be stored so that when the specific item or a similar item comes into stock the user is contacted either by an automatically generated e-mail or directly by the retailer.

Some of the searches sentence-based (e.g.) a search might look like “I am looking for a [CHOOSE AN ITEM] with a weight of [CHOOSE A NUMBER] carats.” These searches are augmented by an “advanced search” and another called “search by combination.” The last two are much the same but the advanced search adds additional criteria that allow users to search by weight and color. The most powerful search is the full text search that allows users to enter any criteria they wish and the database will either return all matches or a list of suggestions. For example, a search for an item not in the database, say a 12 mm Round Peridot gemstone, would yield a screen with the following options for the user: a list of other shapes available in that size and type of item; a list of other types of items where the size and the shape match the user's search criteria; a list of results that match only one of each of the selected fields. The user can click on any one of these options and the search will continue.

One unique search novel to the present invention is the “Search by birthstone” which allows users to select a month and a shape for a birthstone and the system will return the matching birthstone(s) for that month from the database. In addition, the user may select a piece of jewelry and ask the system to price the piece on the basis of a set of birthstone selections. For example if a user finds on the site a three-stone ring with diamonds and sapphire, but would like to replace those stones with three other birthstones, the user can select the three months and get a price range for what that ring would cost with those birthstones in it. The user can do this for any quantity of birthstones, in any size or shape, for any piece of jewelry including, but not limited to, rings, earrings and pendants.

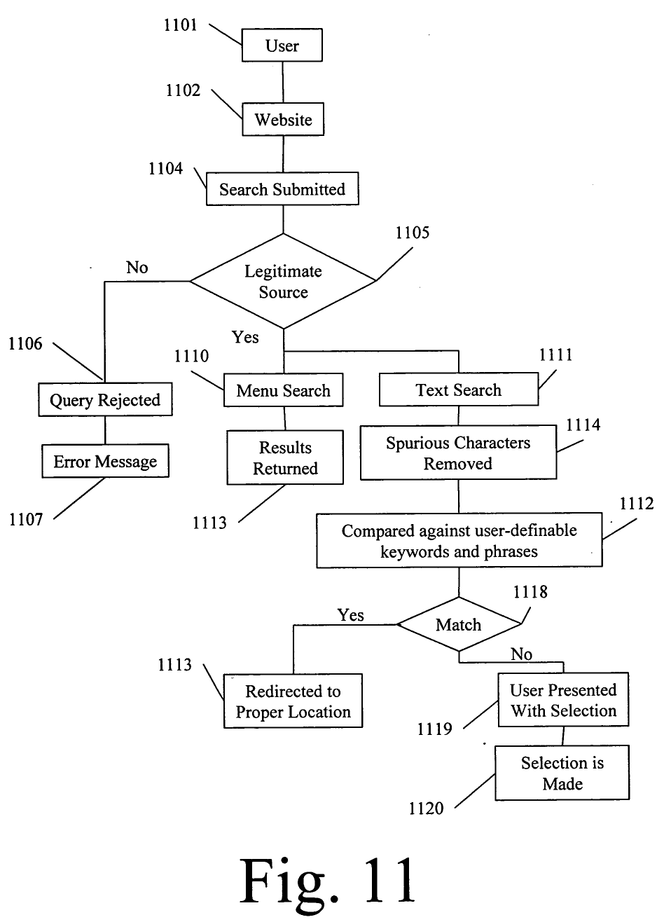

Now referring to FIG. 11, a flow chart is provided for the process of conducting a search. When a user (1101) conducts a search either directly through the web site of the present invention (1102) or an enabled client web site, the system of the present invention processes the query according to the following process. Once the search is submitted (1104), the system checks to see if the source of the inquiry was from a legitimate source (1105). It checks the user identification embedded in the query to see if the query is coming from that client's web site. If it is not, the query is rejected (1106) and it gives an error message (1107) saying the query cannot be authenticated. If the query is from a legitimate host, then the IP address and the machine name of the person submitting the search is checked against a black list as each account has it's own user-definable black list. If the search was conducted using drop-down menus, then the system returns results for those items that match the field selections, but if the search came from the free-form text search then the system first removes any spurious characters such as periods, spaces, commas or semi-colons from the entry.

Once the entry is free of spurious characters the system compares the entry against a list of user-definable keywords and phrases (1112). If it matches one of these, then the user is redirected to another web page that addresses the contents of their query (1113). For example, a jeweler may choose to redirect someone who enters the term “engagement ring” to another page with more information before giving them results from the database. The system checks to see if the entry is a number. If it is, and the number does not match a millimeter size in the database, then it will assume the person is looking for a particular item number. But if the number occurs in the list of sizes, then it will ask the user if they are looking for that item number or for all results where the size field matches their entry. Once the user selects the correct entry, the search will continue.

Next the system looks at each word entered to try and best match it against the contents of the database. If there are “near matches,” where the system finds one or more entries that are close, then it will present the user with a list of these items and once the user selects and entry the search will continue.

Search results are presented to the user in list format with thumbnail images on the side. If there are matching entries from multiple categories the user is given a selection of matching entries with a button at the end of the list that says “Show me all matches from this category”. Each search result has the option to view more detail or to add the item to the wish list.

Prices for some categories are presented in ranges and depending upon the item could be by weight or per piece. For a finished piece of jewelry that includes gems, sometimes the gems can be upgraded, downgraded or changed to increase of decrease the price. In these instances, there is a price range and, in addition, there is a price “as shown” which is the price of the item with the specifications shown on the screen. Prices that have been discounted settings appear in red in the list.

The system of the present invention supports multiple currencies including but not limited to United States dollars, Canadian Dollars and Euros.

While the present invention allows wholesalers to share their inventories with retailers, it also allows retailers to share their inventory with one another. Retailers can add their own items into any category and these items can be, at the jeweler's option, shared with other jewelers on the network. In any given set of search results, there can be three classes of items: items belonging to wholesalers & distributors and manufacturers, items uploaded, maintained and belonging to that retailer, and shared items from other participants on the network.

Depending upon which of the previously mentioned classes the merchandise falls into, and the options set for it, items will either have: an availability status (e.g.) 1-2 Days, 2-3 days etc. if the item is a shared inventory item and would have to be shipped from one retailer to another or, if the item needed to be shipped from a wholesaler/distributor, to the retailer; add to wish list; add to shopping cart, put this item on layaway; place a hold on this item; or customize it. The layaway feature would initiate the usual e-commerce collection of contact/credit information followed by verification and confirmation. The terms for layaway are set by the jeweler through the system. The “Place a hold” feature allows retail customers to hold an item for a given number of days, paying a small amount per day for the hold. The amount is charged daily to a credit card and is fully refundable if the person buys the item within the hold time. Otherwise the hold comes off and the retailer keeps the money.

The “customize it” feature of the invention allows retail clients searching client sites to customize a given item. If, for example, the user wants to change the “head” on a ring, they can select from a selection of different heads using that are available through the supplier/manufacturer databases on the system. So too with strands where, for example, the customer could choose a different clasp. And if the customer wanted to simply change the metal of the ring shank, the system can make that change too. If a user chooses to change, for example, a gem or number of gems in shown in the item to another, the system will go and search for available replacement gems from the participating supplier databases and provide pricing for that option. The system relies upon the interaction of the participating supplier databases to provide retail clients with many options to customize their purchases as well as price ranges that change depending upon the change made to the item. Customized items and in stock items for which the client has expressed an interest can be saved in the wish list stored under the clients name.

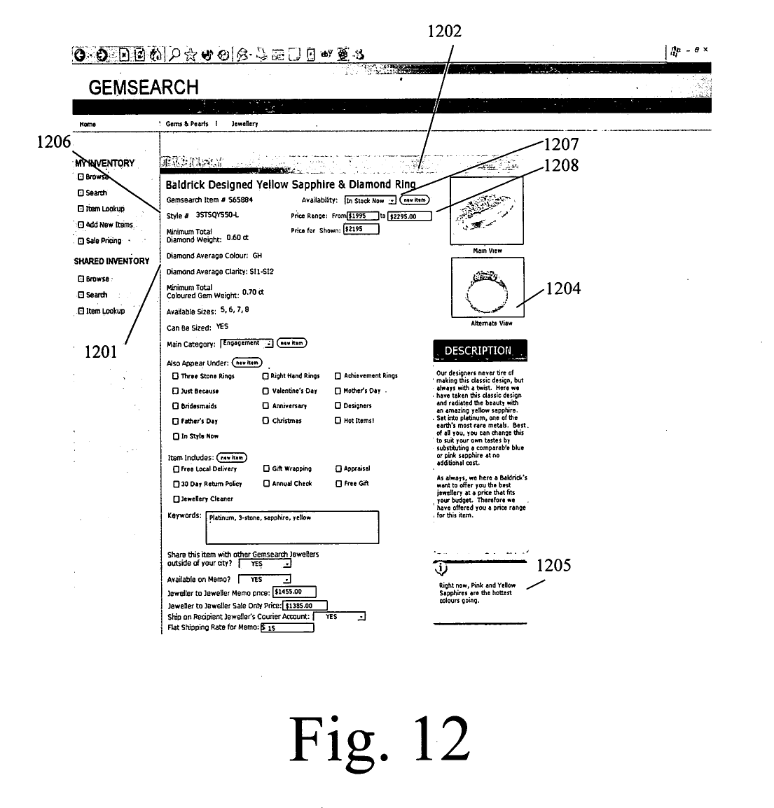

Now referring to FIG. 12, the attributes (1201) supported by the system of the present invention is provided. Each type of item (1202) has different attributes (1201) that the system supports: for example a piece of China will have a pattern number whereas a ring will not and neither will a loose diamond or gemstone. So excepting their different attributes (1201), the following are the features that all items share: A free form text description (1204) is provided. Instead of filling out fields to describe something, the client entering the item can enter a descriptive, sales oriented paragraph regarding the item. This field is searchable, meaning that descriptive terms such as grades can be entered here and still found by the search routine. Item notes (1205) are little interesting facts or selling points that promote a specific item or class of merchandise. They can be or entered into a specific item or they can be assigned to appear with categories of merchandise and/or keywords. Where multiple notes are assigned to one category, the one that contains keywords that most closely matches either the search results or specific item is the one or one(s) that will be displayed. In search results up to 2 notes can be displayed. Style number (1206) is the stock number used by the owner of the item. Availability (1207) is the amount of time it would take for the jeweler to have this in their store. If the user clicks on the new item button next to this field, they can add their own menu items and those new items will be available to all clients. Price range (1208) displays two prices, a from price and a to price. If the item is a ring or watch or bracelet or anything where the size can be altered to fit the wearer this will be displayed.

Retailers can use the inventory management and point of sale system independently of the supplier database or in conjunction with it. When retailers add their inventory to their enabled web site, they can also use it for their point of sale system. As such, the database of the present invention functions as their inventory. The retail component handles: repair take-ins, custom orders, customer database, appraisal generation & archiving, and reporting functions. The system of the present invention, including reports, can be accessed entirely through an Internet browser or by means of software installed on the local jewelers' computer. This makes the system unique within the industry. Data from legacy point of sale systems can be exported into the system database while accounting data can be exported to third party accounting applications.

For inventory valuation, the system provides a calculator function that works in a fashion similar to a spreadsheet. The price by piece or by weight, the inventory value and the weight or number of pieces fields all interact within the calculator. They are related because the price per piece/weight multiplied by the number of pieces or weight will give the fair inventory value for the item. So that if any one field is changed the other two values will be changed to reflect that change. The calculator function allows the user to see how the values will change without actually making the changes to the database. Once the figures are correct, the user can click the UPDATE button and the values in the calculator fields will replace the actual values that exist in the database.

Items can be added using a form the same as the one shown in FIG. 2. Or if many items are being added, some with similar characteristics, the user can use the add lots function. When using this function, the system “remembers” field selections from the previous items and duplicates those fields for the next (new) item while incrementing and automatically assigning an inventory id number. The system can also optionally set a flag that will indicate that the new inventory item needs to have an inventory label printed for it. By clicking on the photo tab, the user can select a specific photo for the new item. And by clicking on the browse tab the user gets a list of all of the entries they have made during their session with the add lots function. They can double-click on the items displayed in the browse and edit the entire record.

The system may also include a check price by item number feature. This function retrieves all transactions from the approvals, invoices and quotations for a specific item number and displays them in table form. The results show the source document on with the date and the details of the item and the price. Also displayed are competitor pricing for like items with the list price range for that item. These pricing results can be sorted, grouped or printed.

The same pricing information can be had by entering some or part of the fields in a check price through the combination feature. In this case the results are much broader and can, optionally, be grouped by company name. Users can also check what they have in stock by filling in at least one of the fields in this function. The more fields they specify the more precise the results.

The system of the present invention is designed so that, without using either a keyboard or a mouse, the user can use a bar code scanner to quickly scan item numbers and codes. Once the first field is scanned, the system checks to see if the entry is numeric or alphanumeric. If it is numeric it assumes that the user has entered an item number and proceeds to look for it. If the entry is alphanumeric the tries to find the item by matching the entry with the contents of either the code1 or code2 field.

Inventory Level

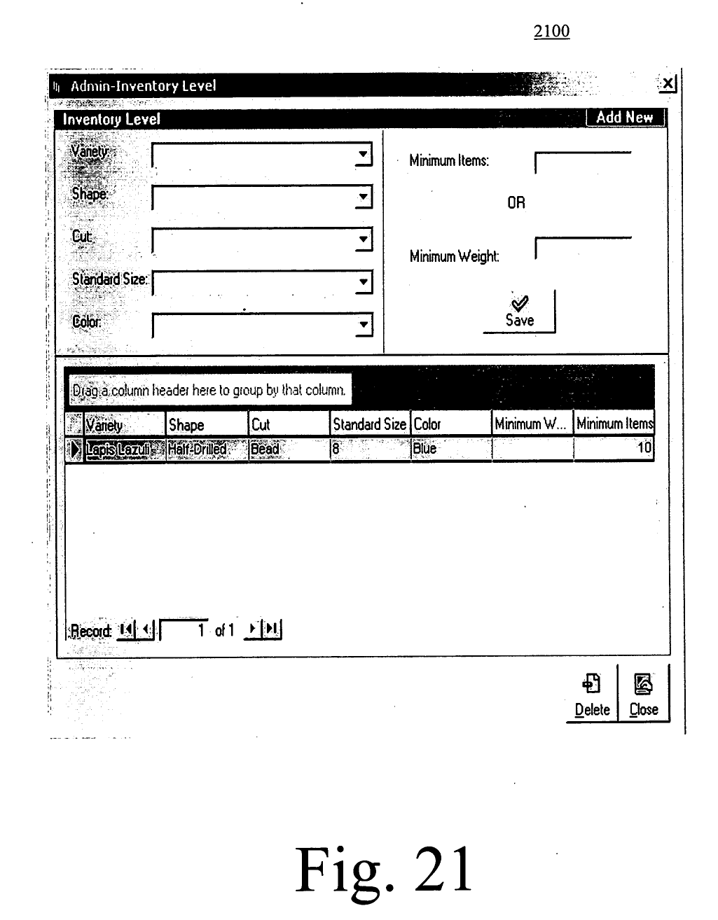

Now referring to FIG. 21, the system of the present invention enables a user to set a series of thresholds beyond which the item should be reordered (2100). Based upon a combination of the variety, shape, cut and standard size fields the system prompts the user to enter a threshold that might look like this: “Amethyst, Round, Faceted, 2.5 mm, 1000 carats”. The system uses drop down fields for all entries except for the number. Another might look like “Cultured Pearl Strand with 14K Yellow Gold Clasp, 18″, 6×6.5 mm, 40 pieces”. Finally, the system can also set thresholds based upon the contents of either or both of the code1 and code2 fields. So, for example, if the jeweler uses a White Gold 4 prong head, part number FE3944 he can set a minimum inventory level for this item. If the inventory drops below these thresholds, the system can automatically prompt the user to place a re-order immediately or to hold it on the order list. The function supports both printed and on screen reports to show the current inventory levels are as compared to the thresholds or just the items that have fallen below their thresholds.

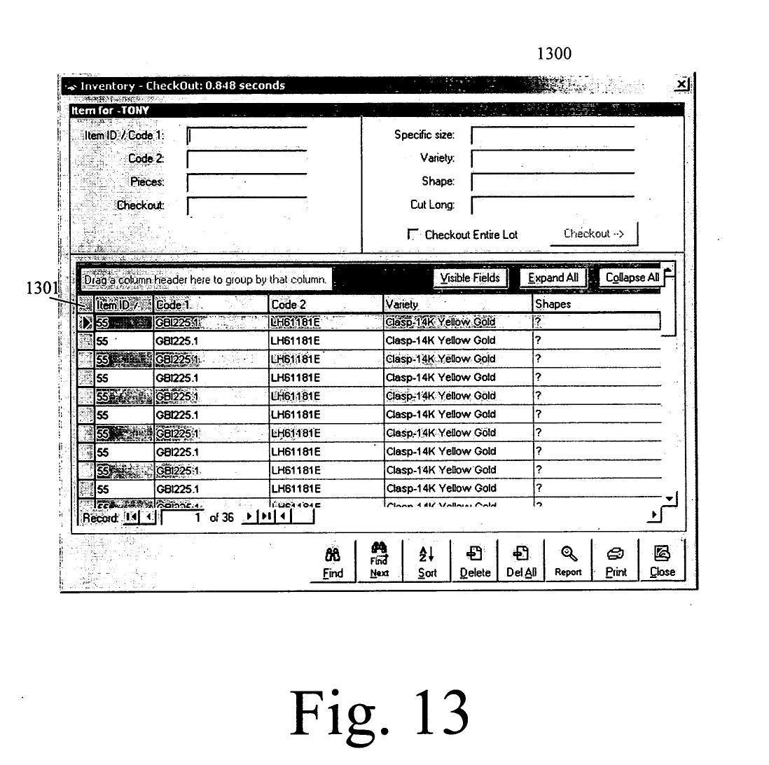

Now referring to FIG. 13, inventory, when consigned to salesperson or taken to another location like a trade show must be tracked and accounted for. An inventory checkout function (1300) allows the user to create a list of items (1301) that are taken off premises for one reason or another. It is designed so that, without entry from keyboard or mouse, the user can use a bar code scanner to scan the inventory labels' bar coded item numbers and either checkout the entire contents of the item or part of the item. The system also provides a report that values the items for insurance and record-keeping purposes. For trade shows the system stores this information until it is removed. It also has facilities for sorting and searching the entries.

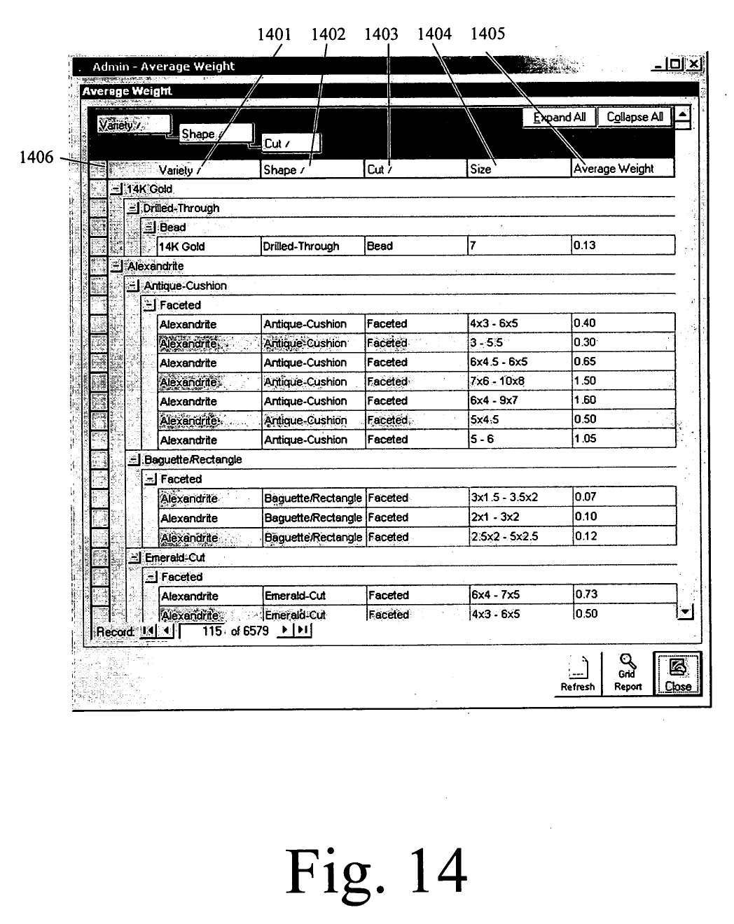

Now referring to FIG. 14, using a combination of variety (1401), shape (1402), cut (1403), and standard size (1404) an average weight function scans through the database for matching items in order to determine an average weight for each combination (1405). A table (1406) can be rebuilt at any time based upon new entries and is used for reference information and to calculate the cost per piece for items that lack their own content in the average weight field.

The system of the present invention can also generate a buy list of out of stock or low stock items that need to be replenished. The user can add items manually or items can be added automatically when items in the inventory levels function fall below their threshold. Out of stock items can be printed or faxed to suppliers on a purchase order form or they can be electronically transmitted to the supplier.

Customers' Module

The present invention contains a customers' module that maintains a list of all clients including their business address, shipping address and other contact information. The system supports the creation of user-definable categories for different types of clients. It also supports the creation of groups of customers that receive discounts on their purchases. Local taxes can be created too. Any one client can be placed in single or multiple categories and groups and they can be set up so that their local taxes are applied to purchases.

Each client has an individual set of preferences that can be set so that any transaction initiated on the client's account will have the values set in the preferences automatically applied to their transaction. The type of information set in the preferences is user definable but currently includes the following: the number of duplicate copies of paperwork the customer would like; the customer's preferred means of shipping which is a selection from a user customizable list of couriers and can also include the courier along with the client's account number with that courier for instances where the client would like shipments billed to their account; disclosure level: certain kinds of merchandise, principally precious stones and pearls, that have undergone single or multiple treatments can have this information disclosed on paperwork either by means of industry standard abbreviations or, in addition to the abbreviations, a full explanation of what those letters mean.

For example the industry code for items that have been dyed is “D”—a full description would be “D-Dyed” and the system would also list how prevalent dying is for this kind of merchandise and how stable it is; Default Terms: the standard terms under which business is usually conducted with the client—the list is user definable and individual invoices can be changed to any of the terms available in the system; preferred means of payment: how the customer usually pays in a user definable list that includes, for example, cash, debit, VISA, MasterCard etc; State/Provincial Reseller number: where a license to do business is required this field allows the user to enter the relevant government issued numbers; Currency: A user definable list of currencies that currently includes but is not restricted to, Canadian Dollars, U.S. Dollars and Euros.

If the customer has filled out any forms, they can be attached to their customer record in Adobe Acrobat PDF format. Credit Applications, Government Forms, copies of business cards, correspondence or anything else that can be put in Acrobat PDF format can be become a part of the customer record. An unlimited number of documents can be attached and the user can use arrows to move back and forth between the attachments. Once the PDF file(s) have been attached they appear in the customer record as exact facsimiles of the originals and can be individually printed.

Users can optionally store credit card and courier account information about the client. The system can support an unlimited number of entries for both courier accounts and credit cards. So if the client has multiple courier accounts this information can be stored here. The list of courier names is customizable and once any courier accounts have been entered, this information appears in the Ship Via selections in other parts of the system as well as being available as a shipping preference.

In addition, jewelers can set “alerts” for specific customers whereby a message appears if a certain event is initiated. For example, if a customer has paid with a bad check in the past, the jeweler could set an alert with this message to appear if a new invoice is opened for that client. Or if a customer particularly important to the business, a message conveying that information can be displayed too. The system supports an unlimited number of user customizable messages and triggers.

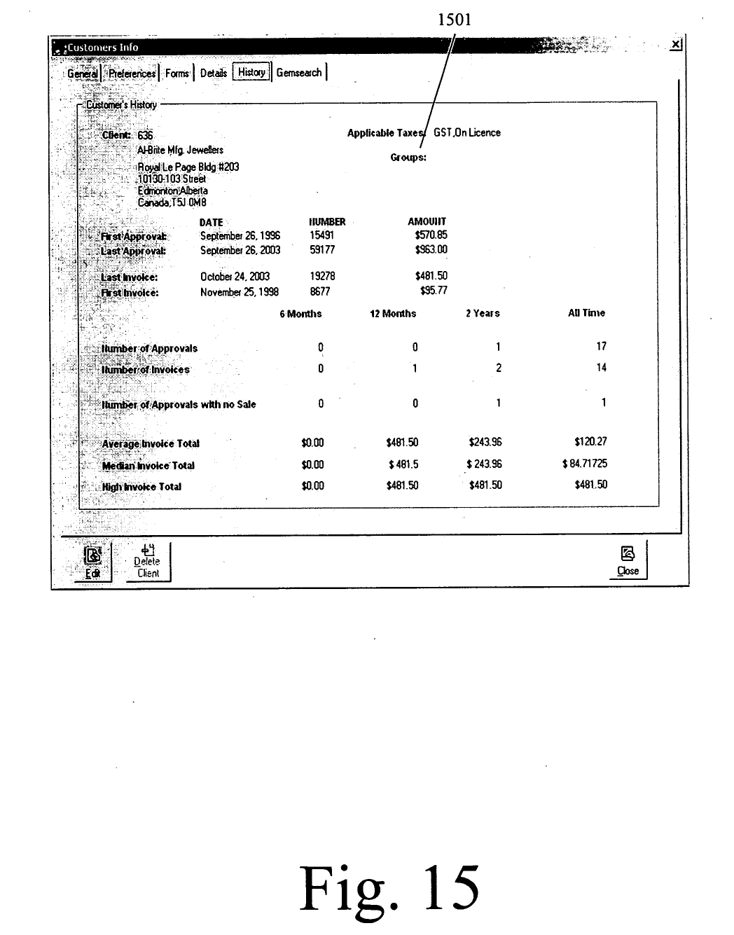

Now referring to FIG. 15, the customer history function shown gives a quick overview of the of the transaction history for a selected client. The function provides the user with a visual report of groups (1501), categories and taxes that are applied to the client as well as the first and most recent consignment and invoice transactions. It also provides a count for the number and type of transactions that have occurred with the client in the past 6, 12, and 24 months (these periods can be customized) as well as a count for the life of the account. When inventory is sent on consignment and not sold, the system keeps track of the number of times this happens over time. Metrics such as this, combined with others such as the average, median and high invoice total combined with the transaction frequency counts is intended to give the user an idea of the accounts importance to the company.

Server Security

Client accounts can be added to the present invention simply by checking a box. There are three settings utilized for the described embodiment of the present invention, though other security levels can be added. The first, most basic, setting allows retailers to search the supplier's inventory database directly though the supplier own web site. Searches conducted through the supplier's site are at the wholesale cost and are not marked up to retail prices (as happens in some functions of the propagation layer). Suppliers, manufacturers and distributors can still use features such as the dollar discounts or percentage discounts to promote items to the retailer. The second level adds the retail client to the website with the store locator that serves as a front end for both those retailers who don't have a web site of their own as well as those who do. This setting activates the account on the front-end site. The third setting allows the clients to run the web service directly from their own site. Though they can still be listed in the store locator of the generic retail site, if a user selects their store instead of using the generic site to conduct their searches their browser will be redirected directly to the client's own site where the service is running.

Approvals Module

Approvals forms are used when merchandise is sent out on a short-term consignment. If the item is sold, then it is invoiced using one or a number of approval forms as a source documents for an invoice.

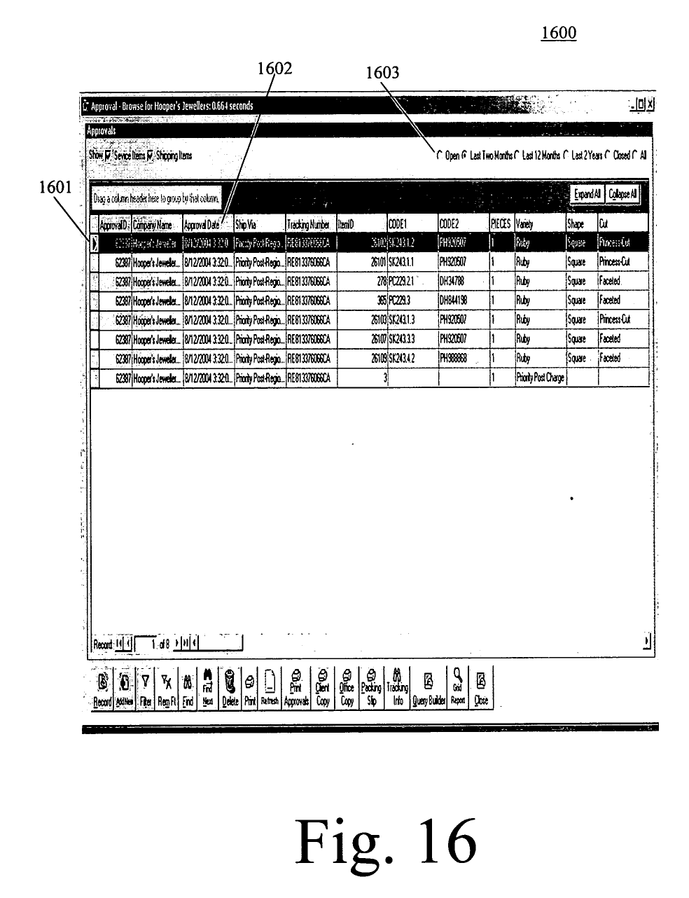

Now referring to FIG. 16, a browse screen (1600) can show any items from the approvals database based upon queries made upon any field available in the database. The browse screen (1600) shows every line item (1601) from the approvals and all of the associated details. Additionally, data can be selected based upon the documents' dates (1602). There is a set of radio buttons (1603) at the top of the screen that show various periods of time ranging from the “last two months” to “all time.” These can be customized depending upon the user's preferences. The first button displays only “open” approvals. These are approvals that have not been finalized or “closed” and are still in progress.

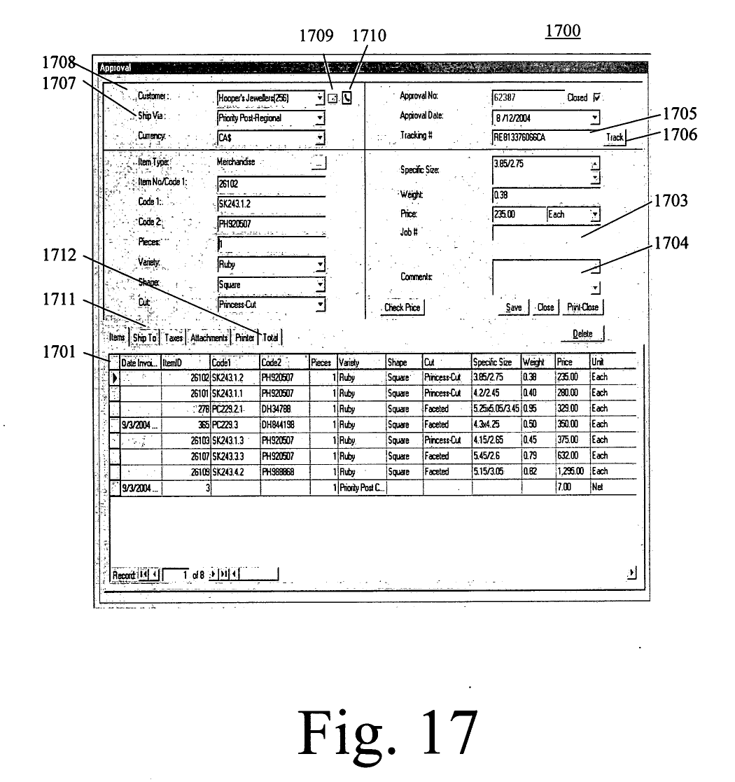

Now referring to FIG. 17, the approval entry form of the approval module illustrates that when an approval is opened or edited, the data is placed in screen form (1700). At the bottom is a list of items (1701) on the approval including the details of the item. In addition to inventory items (1701), services such as repairs, setting, appraisals and any other service item involved in the manufacture, repair or fabrication of jewelry is listed and charged for here. Shipping charges and any associated tracking information is listed here as well. Any of the above items can be edited or changed through this form. Each item (1701) has a field for a job or order number for references purposes as well as a comments field (1704) for additional information. Items can be charged by weight, by the piece, or NET for one price all the entire line item.

The system of the present invention also has a pricing guide built in. When clicked, the system opens up a new window with a list of prices charged for this particular inventory or for any other items like it. If the client has had the same item previously, those prices are listed first and are demarcated either by an asterix or the text is displayed in a different color. This function can check competitor's prices. If there is a style number unique to the product, the system will search other retail web sites outside of the system and return the prices from those sites. In addition, competitor prices for like items can be added to the system database and will appear automatically in this window.

For items being shipped, the system has a field for the tracking number (1705). There is a button next (1706) to the tracking number (1705) and, when clicked, the system will open a new browser window and automatically display the tracking information from the courier's web site. The system accomplishes this by first checking the ship via field (1707) to establish which courier is being used, and then feeding the tracking number from the tracking number field (1705) to that courier's web based tracking system. Next to the company name (1708) are two icons (1709 & 1710) that, when the mouse is placed over them, display a small window with the customer's address information and phone numbers. When the mouse is moved away, these disappear. These are used so that the screen is not cluttered with sometimes-unnecessary information.

If an item is being consigned to one party but shipped to another, the user can enter the ship to information under this tab (1711) and the approval form, when printed, will show the information entered here under a ship to address. If the customer has a ship to address as part of their customer file, that information will automatically be entered here. When this function is being used, the user can elect to print a packing slip, which contains the same information as the approval form, but, for privacy purposes, any pricing information is not listed.

Local taxes and their rates that have been added as part of the customer file as appear under the approval module. The taxes and their rates are automatically selected and any discounts (set through the Groups in the customer file). Selected taxes, discounts and their rates can be changed under the approval module. They are set by means of the information stored in the customers file, but since this information is saved with the individual approval, they can be changed or adjusted without affecting the selections or values stored in the customers file.

User can elect to attach one or more Adobe Acrobat files to their approval forms. This function can be used for attaching any extra information such as appraisals, certificates or other documentation about one or more items listed on the approval. But anything in the Acrobat PDF format can be attached as part of the approval document.

The user can elect to print the approval to a printer other than their default printer on the network. They can also choose a different printer to print the attached PDF files. If, for example, a person in another area of the office is preparing the approval, it can be sent to a printer near to the receiving client or in the shipping department. A user may want to print the PDF files to a color printer rather than a black and white one and so the option of printing those documents to a separate printer is supported.

The total tab (1712) gives the user a total value for the approval for reference or insurance purposes.

Users can also query the approvals database by filling in one or more fields. The system will then retrieve all matching records and display them in a browse screen. The customer or company name can optionally, group the results.

Approvals, invoices and quotations can, depending upon the layout, contain a given number of items. These forms can be customized with the user's company name, contact information logos etc. When a new approval, invoice or quotation is being created, once the number of items exceeds the number that can be printed on one form, the system automatically generates a new approval/invoice/quotation number.

The form can, optionally, contain information about the items on the approval. In this example, any varieties of gemstones listed on the approval will contain reference information such as the hardness, toughness and care and handling information. If the user has selected partial disclosure of treatments, the approval will also list either the letter codes applicable to that variety or a full disclosure that lists common treatments for this item, their prevalence and stability. The form can also contain extra information about the company. In this example, the company is promoting new product, advising clients of market trends and cross promoting with other suppliers.

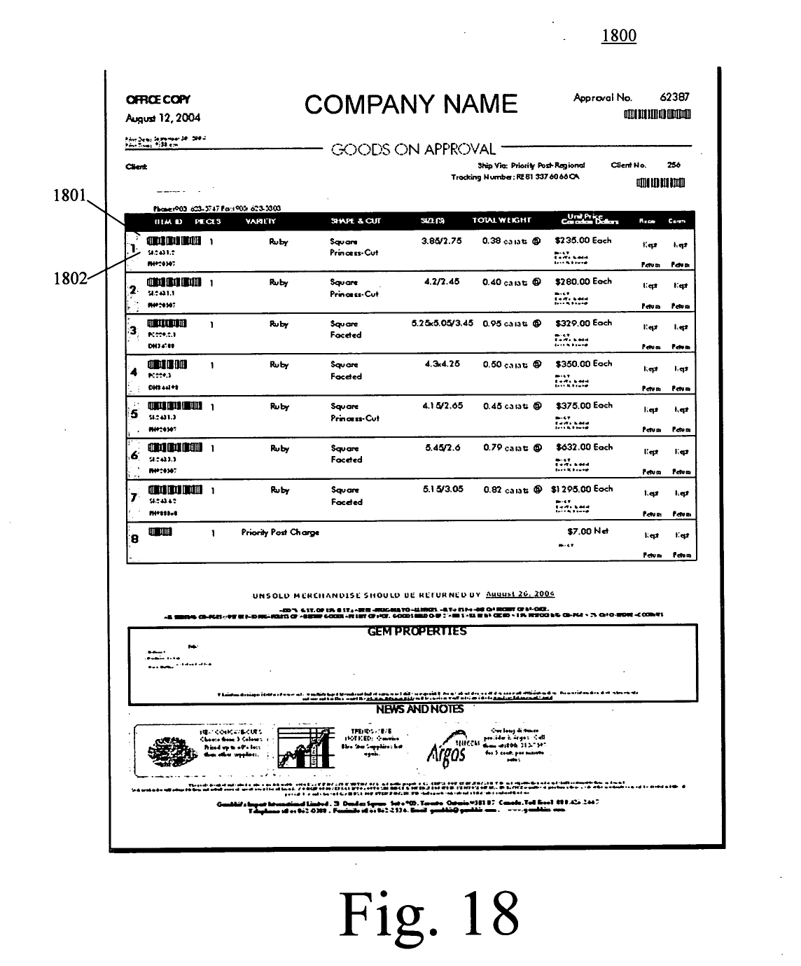

The system in this embodiment produces two copies of the approval. One, shown in FIG. 18, the in house approval copy (1800) that contains bar-coded item numbers (1801) and stock codes (1802) and another, client copy, that does not have this internal information. Since the merchandise described is on consignment, the system adds a user definable number of days to the approval date (in this example 14 days) and lists that date as the day by which unsold merchandise should be returned.

Invoices Module

New invoices are created either by entering item number or stock codes or by referencing an item on an existing approval. Approval items can be added individually or the contents of an entire approval can be added at once. All items can be edited to change any of the field contents including the price. Approval prices are automatically discounted if the client is a member of group that receives a discount. The Ship To, Taxes, Attachment, Printer and Total tabs function the same way as they did in the approvals module. The payment tab allows the user to change the terms of the invoice and the means of payment.

The system of the present invention also checks to see if that approval item was previously invoiced and, if it has, it will inform the user and ask them if they want to view the invoice where that item already appears. When an invoice is printed and the inventory is reduced to reflect the quantities sold out of each inventory item. In addition, where prices have not been discounted, the system updates the price range for the item if it falls outside of the existing price range.

In order to keep price ranges from being artificially skewed by low margin sales, the system uses the mean price for a given inventory item as the start for the price range and the highest price charged as the end of the price range. When an invoice, approval or specific quotation is printed, the system automatically updates the prices for the items on those documents. Invoices can be browsed, queried and filtered by any field in the same manner as the approvals module. Additionally, invoices can be exported to popular accounting programs by means of either a range of invoice numbers or a date range.

Credit Notes Module

Credit notes are generated using the invoice(s) as source documents. The user enters the invoice number and the system fills in the client name and currency that appears on the source document. When the invoice item number is entered, the system retrieves that line item from the invoice and places the contents on the credit note entry form. The size field can be edited along with the price and the rate (Each, Per Carat, Per Gram, NET). The user enters the number of pieces returned and/or the weight returned and the system saves the line item. A single credit note can contain items from different invoices.

Quotation Module

The system supports two types of quotations: one that refers generally to type of service or good where there is no specific item being quoted. The other type refers specifically to a special service or inventory item. Both formats support a “from” and “to” price range and multiple currencies. And both have a field to indicate how the quote was communicated to the client and on what date.

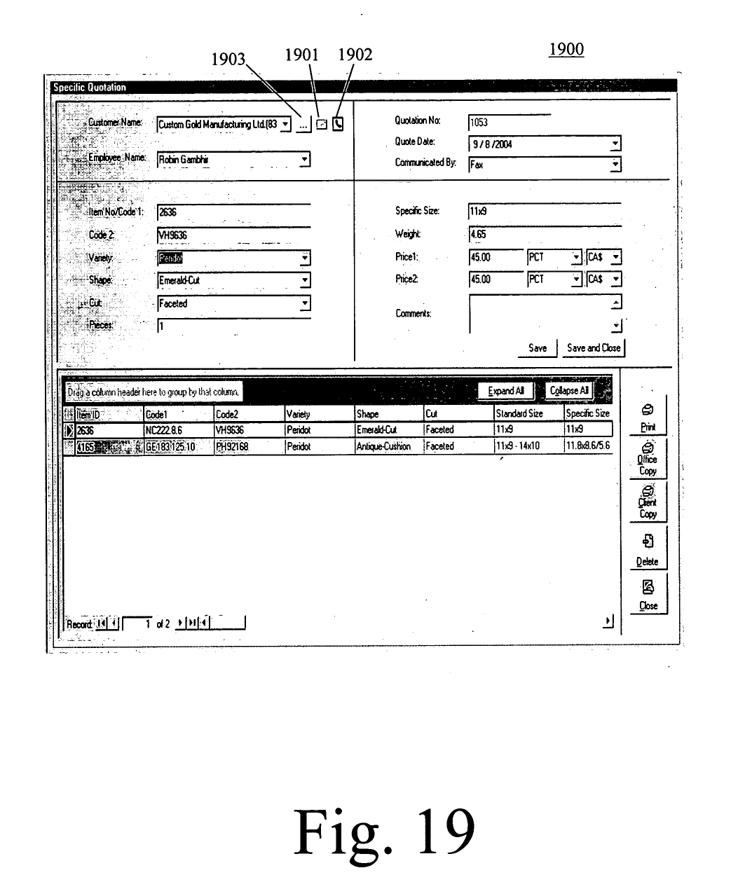

Now referring to FIG. 19, both entry forms (1900) have the same mouse over address (1901) and phone number buttons (1902) and, where a person is not already in the customer's database but requires a quote, there is a “quick add” button (1903) that allows the user to entry that person into the customer's file before making the quote. Both quotations, when printed, show the care and handling information as well as the announcements at the bottom of the screen. Additionally, the system of the present invention supports a series of utilities and admin functions that help manage and maintain elements of the system.

The system of the present invention also includes a function used to add or edit the different varieties of merchandise in the system. Varieties can be any item or component used in the design and fabrication of jewelry. Inventory items that have been enhanced or treated and/or require care and handling instructions can be maintained here. A new item can be entered at it will thereafter appear in all menus unless it has been removed by the Elimination List feature.

The “shape” field can contain any text information. With gemstones it is used to describe the outline of the gem; with strands it contains the length of the strand; with beads it contains information about how or if the bead is drilled, with chains it describes the style of links; with watches it describes the shape of the case etc. This is a descriptive field that can be adapted to fit the type of item. Users can also enter short forms or abbreviations for use when printing a stock label as well as attaching an image representing the contents of that field. These images can also be printed on a stock label.

The “cut” field is another multipurpose field that can contain different data depending upon the type of item. With gemstones it describes the style of cutting used, but with pearls it may describe some attribute of the beads and with finished jewellery it may contain a different descriptor. This field also supports short forms and abbreviations as above.

The “color” field contains single or multiple color descriptions that are used to describe the color(s) of or occurring in the inventory item. This field is used primarily for web-based searches where the color of the item is important and therefore becomes part of their search.

The “appearances” file contains a list of generic descriptive sentences that can be attached to an inventory item. This list can be edited or added to here. The selected description can be, optionally, display in the item detail of the search results of a site using the web service.

Default photos are displayed by the system when a photo of a specific item is missing the certain of the item's field's match the same values in the default photos list. Every valid combination of the variety, shape and cut fields that exist in the inventory are replicated in the default photos table. The user need only select a representative image that can be displayed when the contents of those fields is matched in the inventory. If there are a number of photos to be selected, if they are placed in the space where the default photos reside there is a button that will scan that space and populate the default photos list automatically.

The retail, wholesale and manufacturing inventory and process management databases can be, for security reasons, stored on each individual companies' own server with all or part replicated on the Internet. To facilitate this, the system includes a synchronizing function that checks the local database every 1-999 minutes for changes to individual records. Since both the approvals and the invoices module update list price ranges with every transaction, the last modified date and time stamp for each modified record changes to reflect this. The system looks for records that have been updated since the last sync and then uploads changes to the web-based database. The sync routine also checks for changes to the default and specific photos and if there are changes or additions those files will be uploaded to the appropriate space. The sync routine logs all checks and all changes it uploads and displays on screen its current status (as above).

Jobs/Order Module

When a client places an order for a custom made piece of jewelry, make a repair, requests an appraisal or any other such transaction where the retailer, wholesaler or manufacturer is tasked to build something or perform a service, it becomes a job/order. Jobs are broken down into tasks, services and inventory items. A job to appraise a ring, for example, would simply be a one-item entry to appraise the ring. If the client wanted to have the head on the ring replaced and then have it appraised the job would have the following items supply new head (inventory item), replace existing head (task), and appraise (service). A company, be it a retailer or manufacturer, handling this job would have a number of new heads to choose from depending upon how many are available through suppliers using the system. If the jeweler uses a supplier whose inventory is on the system, they can automatically place an order for that item. Once the new head has been sourced, the retailer may send it out to his trade shop to do the work or if it's a manufacturer, the manager may give it to one of his workers. No matter what stage the job is at, the status of the job is listed on the screen along with who is currently responsible for the job. The screen listing all pending jobs is automatically refreshed every 15 seconds so that people in the company know what stage the job is at and who has it. There is a long list of potential status messages and since most business have slightly different processes, they can be completely customized.

In the list, jobs that are due today are listed in red and those due the next business day are listed in purple. Once a job is completed it disappears from the menu but the details of it remain in the system and can be retrieved at any time. Jobs in the browse display can be sorted or grouped by any field. In this example they are sorted by current responsibility. Jobs can be searched and printed individually or as a group.

Companies can also allow their clients to see the status of the jobs they have placed with the company (be it retail customer to retailer or retailer to supplier/manufacturer) through their company web site. Each status, task and service can have a photo associated with it for this purpose. So, for example, if the client has asked for a custom ring they might see a photo of a design with the message “Design Approved” and then another with a casting machine that says “Casting” later another that says “Finishing” showing someone polishing a ring etc. For items that have been shipped, the customer can use the tracking number in the system to track the package in the same manner that the jeweler can through the creation layer.

The jobs module also has a statistics function whereby metrics for a user definable period of time. The user can assess: the number of approvals made and their dollar value; the portion of those approvals that were shipped and those that were local (thus giving the user what percentage of the business is walk-in traffic); the number and value of invoices and credit notes; the gross sales and net sales; the number of jobs during the time; the number of line items; a list of all clients who placed orders during that period of time and the number of orders each client placed; a list of all types or classes of items consigned during that period along with each one's total dollar value, the percentage that dollar value represents of all goods consigned in that period; the weight and/or number of pieces consigned during that period of time; the average price and the mean price for each type or class of merchandise

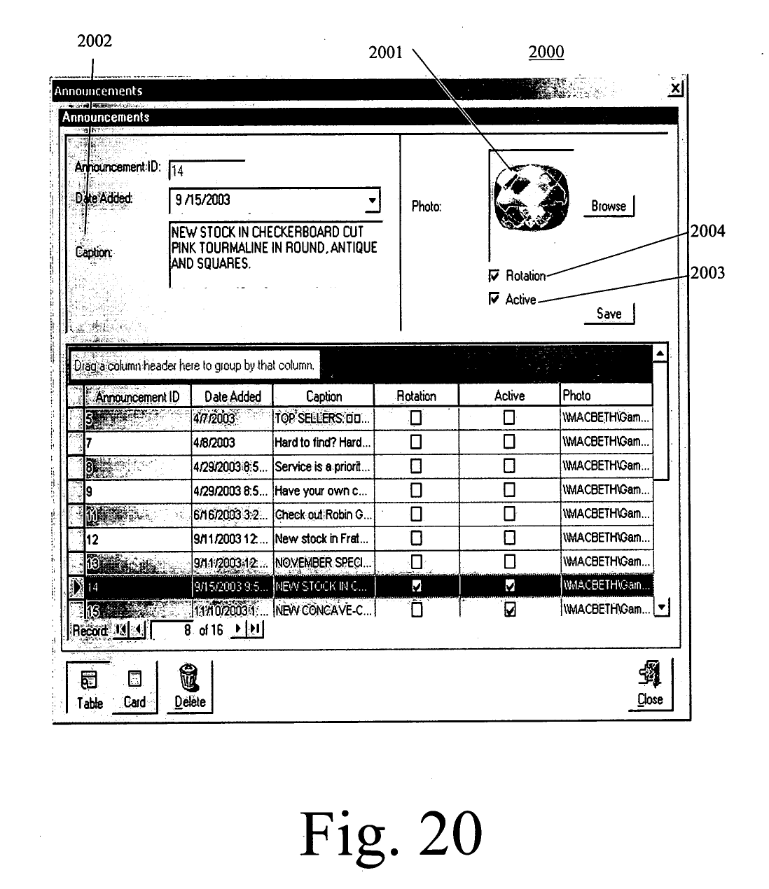

Now referring to FIG. 20, announcements (2000) may appear at the bottom of selected paperwork. They can appear on quotations, approvals, invoices and credit notes to apprise clients of company news, products, services and promotions. They can also appear on the company's web site. Each announcement can have an image (2001) associated with it and when selected by the user it automatically scaled to the appropriate size for the form. Each announcement also has a text field (2002) that appears along with the image on the form. Each announcement has two settings: “active” (2003) and “rotation” (2004). For an announcement to appear at all it must be marked as active (2003) otherwise it is ignored by the system. Announcements that are marked active but not marked as being in rotation are always printed on the forms. Depending upon the space allocated on the form, there can be as many as ten announcements on the printed form and as few as one or none. The system itself can hold an unlimited number of announcements. If there is space for four announcements on the form or the web page, the system will first choose items that are marked “active” and are therefore always printed. If there is remaining space, the system randomly chooses from those items marked active and in rotation and prints those in the remaining positions on the form or site. With some message appearing randomly, the client is does not become inured to the message by seeing the same set of announcements repeatedly.

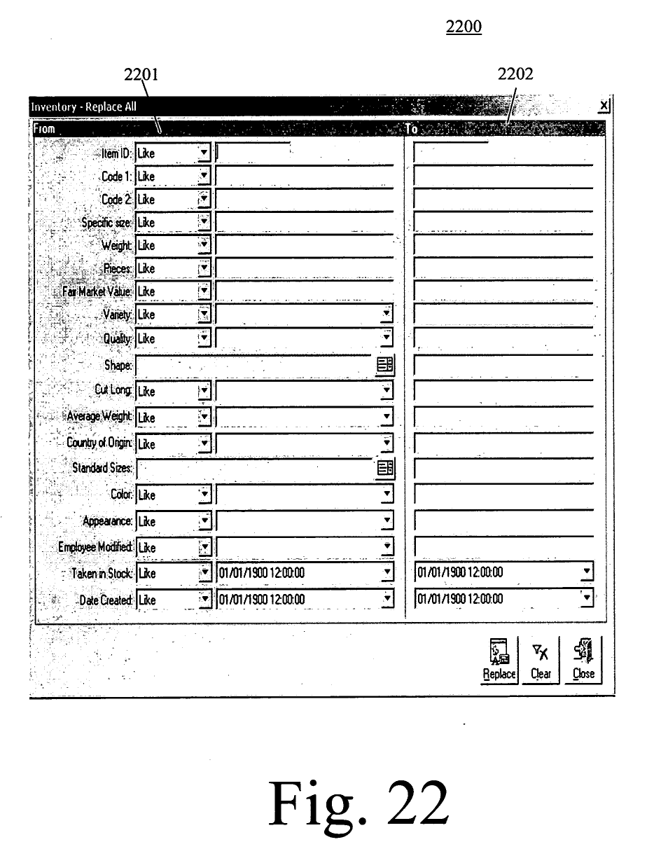

Now referring to FIG. 22, the replace all feature allows the user to change the contents of a given field for a new value based on a selection of records and the criteria. The user first opens a browse window (2200) and, if necessary, sets a filter or a query to isolate the records they want to change. Then they select the REPLACE ALL function and they see a list of all the fields in the inventory database. On the left side of the pane (2201) they enter the criteria for the field and on the right side of the pane (2202) they enter the new value. For example, if there are a group of records where one of the fields contains erroneous data, the user can simply isolate those records, enter the incorrect field value on the right pane (2202) and the new value on the left (2201). This function also supports an UNDO option that will reverse the changes made to the database.

The system supports a customizable list of standard sizes for different types of items. This function allows the user to group those sizes so that a list of sizes appropriate to the item is displayed together. When the user adds a new standard size to the list it appears at the top and the use the arrow buttons to place the size in the appropriate place. The order set in this function affects all menus that contain the standard sizes, system wide whether it is on the local network of the user or the associated web sites.

A tradeshow function allows the user to enter trade shows for the checkout function. It includes, along with the name of the show, the dates for the show.

Although the system continually updates the list prices for items with every transaction, the system has a separate function that allows the user to update the entire database at one time using the same logic described in the dynamic pricing section.

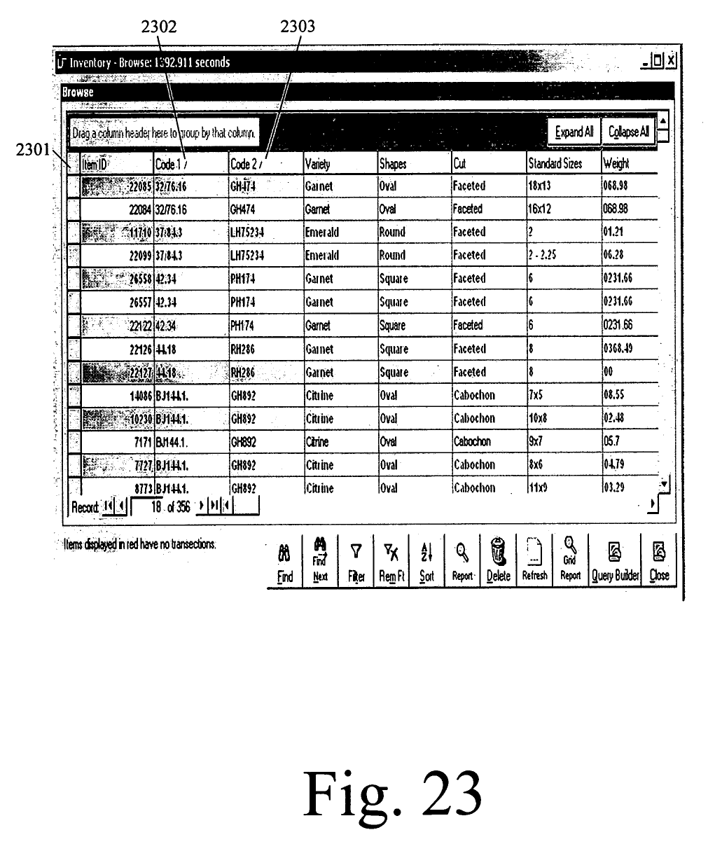

In large databases there can sometimes be items that have been duplicated by different users. FIG. 23 illustrates the browse duplicate inventory items function which searches through the entire database and displays items (2301) that share either the same code1 (2302), the same code2 (2303) or both. Items that have no transactions are listed in red, indicating that they can safely be deleted from the database without disrupting other records that may refer to them.

The browse inactive inventory items function allows the user to isolate inventory items that are not selling. The user supplies a date and the system locates and returns all of the items that have had no transactions since that date. In addition, the system lists items that have no transactions at all. The purpose of the function is to prompt the user to see why the items are not selling, be it a pricing or promotion issue and make moves to remedy the situation.

In another embodiment of the system of the present invention, users may add or edit service items. Since services in some locales are tax differently (or not at all) than merchandise, the system allows services to be classed separately. The first field contains the name of the service, as it would appear in a menu on the system, the second two code fields are optional but can be used when a service it outsourced to another supplier and the contents of those fields would indicate that. The description field is the text that is printed for the service line item as it would be printed on forms such as approvals, quotations, invoices and credit notes. The system can support an unlimited number of services and can provide for multiple vendors that supply the same service. For example, a jeweler may have two or more people that they use for a service such as restringing pearls and the system can support this even though the description may be the same there are treated as discrete items.

The system can support many different courier companies as well as any tracking facilities available through their web site. Information about couriers can be added or edited here. The system has a field for the name of the courier, the name that will appear on the system menus and the text that will be printed on the paperwork. There is a field for a default charge (which can be changed in the document by the user) and it supports multiple currencies.

The checkout function contains a list of recipients along with a list of trade shows. Recipients are any person who is taking the merchandise off of the company premises. This function allows the user to add recipients to the system so that they can be used with the checkout function.

The system supports a logon screen for a usemame and password. All system users have a username, password and access level. The highest level is admin and, even once logged in, an admin must re-enter their login information in order to activate the functions under the admin menu. This function allows users with admin access to add/edit or delete system users.

For accounting purposes, companies are sometimes required to take a snap shot of their inventory at the end of their fiscal year end. This function creates a virtual copy of the inventory that can be viewed later. It does so by copying only the fields that show the quantity in stock and the value to another database while updating the “taken in stock” date field which is used to record that last date on which the inventory item was recorded in this fashion. The live database and this archival copy are linked by means of the item id. Using this function a user can browse previous years' inventory, as they existed at the end of those fiscal years. In addition the user can query, sort and group items as well as print reports based upon the archived data.

In another embodiment, a module is designed for manufacturing jewelers. Again, the system uses the databases of diamonds, gemstones and jewelry making components and allows the clients to cost out and track custom orders, repairs and production runs.

In yet another embodiment of the present invention, added support for finished jewelry, allowing retailers to upload the images, descriptions and specifications for their finished pieces along with pricing information. They will also be able to share inventory so that if a customer is searching a first retailer's web site, if a second retailer's web site (or any other retailer using the system of the present invention) has selected to share inventory that inventory will show up in the first retailer's search results. Retailers who are sharing their merchandise can choose to consign or sell those items to other retailers. At the back end retailers will be able to upload data, put on sales, and manage inventory. There is also a tool that will allow retailers to upload data directly from the retail software they have in their stores.

In another embodiment incentive programs are provided for sale/discount pricing for any item on the system of the present invention, the system also provides for incentives such as mail in rebates and tie-in sales. For example, if a retail customer using one of the system's web sites is interested in a particular item, they may, depending upon the supplier's settings, receive a discount on one or several items if they are purchased together. Thus, a customer looking for a strand of pearls may get a discount if they also purchase earrings to go with it and a further discount if they buy a pendant or ring as well. Mail in rebates on items, offered by either the retailer or the wholesaler, are listed along with the item with a link to a rebate form for that item.

It is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privelage is claimed are defined as follows:

1. A data processing system wherein one or more retailers can directly search the inventory of one or more suppliers, distributors, and manufacturers for pricing an availability information comprising:
a database for storing information corresponding to an inventory of one or more available items accessible via a communications network;
a retail website which is provided access to the inventory database via a communications network;
a propagation layer wherein one or more retail websites are connected to retailer, wholesaler, and manufacturer databases via a communications network;
a creation layer enabling the creation and modification of the databases.

2. The data processing system of claim 1 wherein the propagation layer contains several applications for the control of specific tasks.

3. The data processing system of claim 2 wherein the specific tasks controlled are tiered markups, discounts, incentive programs, transaction logging, inventory sharing, item customization, and order status.

4. The data processing system of claim 1 wherein the creation layer is comprised of several applications which enable the creation of a retail website accessible via a communications network.

5. The data processing system of claim 4 wherein prices can be quoted in multiple currencies, and in prices ranges or a fixed price.

6. The data processing system of claim 4 further comprising a method of inputting inventory items whereby certain fields are automatically filled in based upon the contents of the previous entry.

7. The data processing system of claim 4 further comprising a method of saving a “snap shot” of a database at a given moment in time and browsing and reporting upon that archived data at a later time.

8. The data processing system of claim 4 comprising a method of providing pricing guidance on the basis of: past transactions for the same or similar items; prices from competitors for the same or similar items.

9. The data processing system of claim 4 further comprising a method of automatically re-pricing all in stock items based upon this guidance.

10. The data processing system of claim 4 further comprising a method of marking or tagging inventory items using only a bar-code scanner and without the necessity of any keyboard or mouse input.

11. The data processing system of claim 10 further comprising a method of maintaining inventory levels by providing thresholds below which the inventory level, for a given item or class of items, should not fall.

12. The data processing system of claim 11 further comprising a method of automatically reordering items that fall below the threshold or maintaining a restocking list for those items that do.

13. The data processing system of claim 4 further comprising a method for retailers of sourcing inventory and pricing information using a single or series of database(s) maintained by suppliers, wholesalers distributors and manufacturers on the network.

14. The data processing system of claim 4 further comprising a method of maintaining the retailer's local inventory of: finished jewelry; semi-finished jewelry making components such as precious metal findings; chains; bracelets; pendants; pearls and pearl strands; other precious stone bead strands; precious and semi-precious gemstones; diamonds; watches and watch parts; China; Crystal and giftware with the ability to automatically replenish or re-price it based upon information provided from the databases maintained by suppliers, wholesalers distributors and manufacturers on the network.

15. The data processing system of claim 4 further comprising a method of providing cost estimates for the design, repair and manufacture of jewelry and jewelry related items by:
a method of sourcing jewelry making components such as precious metal findings; chains; bracelets; pendants; pearls and pearl strands; other precious stone bead strands; precious and semi-precious gemstones; diamonds; watches and watch parts; China; Crystal and giftware; and
a method of maintaining a list of services and the associated cost of those services from other vendors that comprise: any and all steps in jewelry design, repair and manufacture; a list of other jewelry related services such as watch repair, gem cutting and repair and restringing.

16. The data processing system of claim 4 further comprising a method for breaking down an order or job into discrete tasks that involve a combination of materials and services and using the information from the system databases to estimate either a set cost or a cost range in multiple currencies.

17. The data processing system of claim 4 further comprising a method of tracking the status of orders by listing the status of each discrete task and assigning, on that basis, an overall status for the orders.

18. The data processing system of claim 14 further comprising an inventory and point of sale system operated through a web enabled browser.

19. The data processing system of claim 14 further comprising an inventory and manufacturing process control operated through a web-enabled browser or by means of software.

20. The data processing system of claim 14 further comprising a system for wholesalers and distributors offering inventory management, consignments, invoicing and analysis operated through a web browser or by means of software.

21. The data processing system of claim 14 further comprising a system of storing client preferences and automatically applying those preferences to new transactions.

22. The data processing system of claim 14 further comprising a method of supplying additional information such as care and handling and, in the case of diamonds, gems and pearls, disclosure of treatments, on printed approvals, quotations and invoices for any items appearing on the form.

23. The data processing system of claim 22 further comprising a method to provide varying detail of the above information based upon a setting in the customer's preferences.

24. The data processing system of claim 14 further comprising a method of storing forms or images as part of a customer record.

25. The data processing system of claim 14 further comprising a method of rating the sales success of an item based upon the number of times it is consigned compared to the number of times it is consigned and sold.

26. The data processing system of claim 14 further comprising a method of rating the sales success of a client based upon the number of times items were consigned to that client compared to the volume of sales generated from those consignments.

27. The data processing system of claim 14 further comprising wherein the use of a series of buttons at the top of a browse screen to quickly isolate records on a user definable basis.

28. The data processing system of claim 14 further comprising a method of storing tax, discount and shipping rates individually with each document so that changing those rates in the system's master file will not affect documents already in existence.

29. The data processing system of claim 14 further comprising a method of automatically attaching many discrete images to many discrete inventory items automatically through a combination of file naming conventions and directory scanning.

30. The data processing system of claim 14 further comprising a method of redirecting secondary documents to a different printer from which the primary document is printed.

31. The data processing system of claim 14 further comprising a method of grouping data displayed in table form into single or multiple groups.

32. The data processing system of claim 14 further comprising a method of automatically discounting prices on the basis of one or more groups listed in the system to which the customer belongs.

33. The data processing system of claim 14 further comprising a system wherein quotations can be made specifically about a single inventory item number or a general quotation that is not necessarily about any one inventory item.

34. The data processing system of claim 33 wherein prices can be given in ranges and in multiple currencies.

35. The data processing system of claim 14 further comprising a method of using a series of standardized texts to describe the attributes of appearance of an item and allow this text to be searched as part of the item's inventory record.

36. The data processing system of claim 14 further comprising a system whereby company news, messages, promotions are printed on company documents with the option of marking some of these announcements to be printed randomly or in rotation and others to be printed all the time.

37. The data processing system of claim 14 further comprising a method by which inventory items that have no transactions at all, or less than a certain number of transactions since a given date are isolated.

38. The data processing system of claim 14 further comprising a method of pricing items in ranges, from low to high, based upon consignment, quotation or invoice transactions made against the item.

39. The data processing system of claim 1 further comprising an inventory module which enables inventory item creation, displays all items in the database, allows a user to construct search queries, print reports, print labels, and sort or group inventory data by a single or multiple field.

40. The inventory module of claim 39 wherein:
a user can organize searches on the basis of life events;
once selected, the participant is presented with items appropriate to the event; and
said user may refine their results by price range, type of item or both.

41. The inventory module of claim 39 further comprising tiered pricing wherein the owner of an inventory item may set a plurality of price tiers based upon the purchase volume of a buyer.

42. The tiered pricing system of claim 40 wherein the plurality of price tiers is based upon weight or the number of pieces.

43. The inventory module of claim 39 further comprising a calculator function wherein a plurality of pricing variables are provided for each item such that when a first variable is changed, the remaining variables are adjusted to reflect the change and yield a valuation of the item.

44. The calculator function of claim 43 wherein three pricing variables are provided for each item such that when a first variable is changed, the second and third variables are adjusted to reflect the change and yield the fair market value of the item.

45. The inventory module of claim 39 wherein a user can attach one or more photos of the actual item if available.

46. The inventory module of claim 39 wherein a representative photo is associated with each item based on a combination of descriptors.

47. The inventory module of claim 39 wherein a user can attach one or more files to the item.

48. The data processing system of claim 1 wherein an onscreen report is provided that details the history of any inventory item in the system.

49. The inventory module of claim 39 wherein a user may view current inventory levels to see if they have breached a present threshold on an item basis.

50. The inventory module of claim 39 further comprising an inventory checkout feature wherein a user may create a list of items taken away from their physical location.

51. The inventory module of claim 39 wherein a user may scan the database for matching items in order to determine the average weight for each combination.

52. The inventory module of claim 39 wherein a buy list is created to show out of stock or low stock items.

53. The data processing system of claim 1 further comprising a customer module which maintains a list of all clients and provides for grouping clients in one or more user-definable categories.

54. The customer module of claim 53 wherein each client has an individual set of preferences that are automatically applied to all transactions.

55. The customer module of claim 53 wherein a client may attach any electronic forms or files to their customer record.

56. The data processing system of claim 1 further comprising one or more user security levels.

57. The data processing system of claim 56 wherein three security settings are used:
a first security level allowing retailers to search a supplier's inventory database directly;
a second security level that adds a retail client to the system;
a third security level that allows a client to run an independent web site that employs the web service.

58. The data processing system of claim 1 further comprising an approvals module wherein forms are used when items are distributed on a consignment basis.

59. The approval module of claim 58 wherein:
the user can attach one or more files to the approval form;
the user can determine the total value of consigned items;
the user can query the database and group results; and
the user can print the approval form.

60. The data processing system of claim 1 and 58 further comprising an invoices module wherein:
invoices can be created by adding items individually or through an approvals list in bulk;
invoices can be created using inventory item numbers
inventory is reduced and revalued to reflect the quantities sold of each item; and
where prices have not been discounted, the system updates the price for each item if is falls outside a predetermined range.

61. The data processing system of claim 1 further comprising a dynamic pricing module wherein a mean or low price for a given inventory item is used as the start of the price range and the highest price charged for the item is used for the end of the price range, the system automatically updated the item price based on the most recent undiscounted price entered on an invoice, approval, or other price quote.

62. The data processing system of claim 1 further comprising a credit notes module wherein a credit note is created based on a clients invoice and the invoice item number.

63. The data processing system of claim 1 further comprising a quotations module wherein a price quotation is generated.

64. The method of claim 1 wherein items for sale can be linked with other related items and offered for purchase at a discount when purchased with one or more of the primary items.

65. The customer module of claim 53 wherein the user can set alerts to present messages to be displayed on the screen when certain actions or transactions take place on a particular customer's account.

66. The inventory module of claim 39 wherein multiple sizes and shapes can be selected for a single inventory item.

67. The data processing system of claim 1 and 60 further comprising an invoices module wherein:
the system can be used for single or multiple points of sale;
the system can operate a cash drawer; and
the system can authenticate credit and debit card purchases.

68. The customers module of claim 53 whereby items customized by clients on the retailers web site, stock items, and items available through other suppliers on the system can be saved in a list for later retrieval and follow-up.

69. The data processing system of claim 1 further comprising a jobs module wherein work orders including repairs, custom work, services items and layaway and hold items are stored.

70. The system of claim 69 wherein outstanding orders are stored along with:
the customer name;
a list of tasks to be completed before the job is finished;
the status of each task along with the person or company responsible for that task;
the cost estimate for each task;
the overall status of the job;
the name of the staff member responsible for the job;
the name of the staff member who made the sale;
the date ordered and completion date;
reference numbers including the job number or bag number, the quote number;
the retail price for the job along with any payment information applicable;
means of payment or deposits made; and
if the order is being shipped, the courier company and tracking number.

71. The system of claim 70 wherein:
the information contained in the jobs file can be sorted, grouped and displayed depending upon user selected criteria;
wherein said jobs can be listed in different colors depending upon close they are to the due date;
wherein the screen displaying this information is automatically updated whenever any changes or additions are made to the list of outstanding jobs.

72. The system of claim 70 wherein any or all of the information stored in the jobs system can be printed on any size of envelope or bag.

73. The system of claim 72 wherein additional information stored in the jobs system may contain specific task information and comments along with reference information which can be printed for outside suppliers of merchandise or services

74. The inventory module of claim 39 wherein a query builder allows the user to select any of the available database fields and construct simple or complicated queries using AND/OR logic along with field operators.

75. A system whereby retailers, wholesalers, manufacturers and distributors share inventory items consisting of: finished jewelry; semi-finished jewelry; jewelry making components such as precious metal findings; chains; bracelets; pendants; pearls and pearl strands; other precious stone bead strands; precious and semi-precious gemstones; diamonds; watches and watch parts; China; Crystal; and giftware.

76. The system of claim 75 further comprising a customization feature that allows a given inventory item to be combined with other items from different vendors to create a finished piece of jewelry.

77. The system of claim 76 wherein said customization feature allows substitution of gems, diamonds or precious metal findings for a given finished or semi-finished inventory item.

78. The system of claim 76 wherein said customization feature re-quotes a price range for a given item where any component such as gems, diamonds precious metal components have been changed or substituted, factoring in set markups, tiered markups, discounts and incentives.

79. The system of claim 75 further comprising a pricing system that offers a range for a given piece of jewelry, suggesting that by upgrading or downgrading certain components a new item in the same or similar style can be had within the quoted price range.

80. The system of claim 75 wherein a user may search for cameos by either the material from which they are made or the subject of the carving.

81. The system of claim 75 wherein a user may search for birthstones, wherein the system automatically determines the type of gem or pearl appropriate based upon the month selected by said user.

82. The system of claim 75 wherein a user may search for and determine the price for a piece of jewelry containing birthstones, based upon single or multiple months selected by the user.

83. The system of claim 75 further comprising a sentence based searching wherein the user fills in missing words from sentences by using menus and text entries and by doing so selects the criteria for the search.

84. The system of claim 75 further comprising a method to search for all aforementioned types of items based upon their color or the combination of colors they exhibit.

85. The system of claim 75 further comprising a method of estimating the price per piece for precious gems and metals usually sold by weight.

86. The system of claim 75 further comprising a method of dynamically pricing items made of precious metals based upon the current market price for that metal.

87. The system of claim 75 further comprising a method of linking related documents such as appraisals or certifications to inventory items.

88. The system of claim 75 further comprising a method of assigning an availability date or number of days to items that are not in stock or immediately available from the retailer.

89. The inventory module of claim 39 further comprising a pricing system wherein the owner of an inventory item may set a plurality of incentives or discounts on a particular item or group of items.

90. The system of claim 89 whereby such pricing can be applied to one or many participants on the network.

91. The method of claim 1 and claim 14 whereby exchange rates for multiple currencies can either be either set by the user, retrieved from another site periodically, or retrieved from another site for each query.

92. The data processing system of claim 4 whereby a user can add an unlimited number of items to a form.

93. The data processing system of claim 4 whereby inventory items that have not had any transactions since a given date and/or any transactions at all are isolated, listed in table form and can be sorted, grouped or printed.

94. The data processing system of claim 1 wherein the user can assess the following:
the number of approvals made and their dollar value;
the portion of those approvals that were shipped and those that were local;
the total number of line items for all approvals;
the number and value of invoices and credit notes;
the gross sales and net sales;
the number of jobs during the time;
a list of all clients who placed orders during that period of time and the number of orders each client placed;
a list of all types or classes of items consigned during that period along with each one's total dollar value, the percentage that dollar value represents of all goods consigned in that period; the average price and the mean price for each type or class of merchandise and the weight and/or number of pieces consigned during that period of time.

95. The data processing system of claim 4 wherein inventory items can be assigned a primary category as well as multiplicity of secondary categories.
